(19) United States
(12) Patent Application Publication
(10) Pub. No.: US 2002/0184120 A1
(43) Pub. Date: Dec. 5, 2002

(54) INFORMATION PROCESSING SYSTEM, INFORMATION PROCESSING APPARATUS, INFORMATION PROCESSING METHOD, AND STORAGE MEDIUM

(75) Inventors: HARUHISA SUZUKI, KAWASAKI-SHI (JP); KUNIO SETO, KAWASAKI-SHI (JP); MASAHIKO TAKAKU, YOKOHAMA-SHI (JP); SHINJI FUKUNAGA, KAWASAKI-SHI (JP); SHINJI FUJIKAWA, YOKOHAMA-SHI (JP); TSUTOMU INOSE, KAWASAKI-SHI (JP)

Correspondence Address: FITZPATRICK CELLA HARPER & SCINTO, 30 ROCKEFELLER PLAZA, NEW YORK, NY, 10112, US

(73) Assignee: FITZPATRICK CELLA HARPER & SCINTO

(21) Appl. No.: 09/324,511

(22) Filed: Jun. 3, 1999

(30) Foreign Application Priority Data
Jun. 5, 1998 (JP) 158044/1998
Jun. 5, 1998 (JP) 158045/1998
Jun. 5, 1998 (JP) 158046/1998

(51) Int. Cl. G06F 17/60

(52) U.S. Cl. 705/30

(57) ABSTRACT

An information processing system includes a first information processing apparatus formed of a group information management module for managing information related to one or more groups each of which is formed of a plurality of shops; and an accounting information storage module for storing the accounting information of a service which all shops included in the one or more groups can offer, and a second information processing apparatus formed of an accounting information management module for setting or changing the accounting information of the service stored in the accounting information storage module.

### BACKGROUND OF THE INVENTION

1. Field of the Invention

The present invention relates to information processing systems, information processing apparatuses, information processing methods, and recording media, and more particularly, to an information processing system, an information processing apparatus, an information processing method, and a recording medium that include an application program for setting and calculating the price of a service (product) which a shop offers.

2. Description of the Related Art

In a conventional technology, shops having the same price rule are grouped, they are managed as a shop group, and the price information of services which the shops offer is managed in the shop group. In the present embodiment, a service refers to a service item or a product item which a shop offers to a customer. Also in the present embodiment, a product or products are included in a service and constitute the service.

A price rule includes the type differences of services to be offered, the type differences of products included in the services, price differences, differences in price change histories and price correction schedules, and differences in prices to be changed according to amounts.

In information management, information is maintained by the operations of registration, correction, and deletion as required so that external inquiries can be responded, and information is prevented from being abused or falsified by limiting information inquiries and operations.

Price management in units of groups, service type management, management of products included in services, and price management according to the number of ordered sheets are achieved by each of photo finishing chain stores or the parent company managing them. Price settings are switched between a slack period and a busy period in an on-line ticket-issuing system at a railroad company as everyone knows.

In the conventional technology, since shops having the same price rule are grouped, they are managed as a shop group, and the price information of services which the shops offer is managed in the shop group, shops or shop groups having different price rules cannot be collectively managed.

When a plurality of price rules are managed, since each shop sets the prices of each service and each product which the shop offers, a large load is imposed for management work, such as registration and correction of the prices of services and products.

When prices need to be changed at a time at a number of shops, for example, a setting error may happen. Capability of preventing price information from being abused or falsified may deteriorate.

When shops or shop groups having different price rules are collectively managed in the conventional technology, all of the price rules which the shops employ need to be managed and thereby a large load is imposed on management. When a shop having a new price rule is established, management means needs to be created again.

The foregoing problems are also generated in shop management and price information management in business deals employing networks, such as the Internet, an independent network, and a local area network (LAN).

### SUMMARY OF THE INVENTION

Accordingly, it is an object of the present invention to provide an information processing system, an information processing apparatus, an information processing method, and a recording medium that allow the accounting information of a service which each shop can offer to be managed easily, flexibly, and collectively among a plurality of shops having different price rules.

Another object of the present invention is to provide an information processing system, an information processing apparatus, an information processing method, and a recording medium that allow accounting information for shops which can provide a certain service to be collectively or independently set and changed among a plurality of shops having different price rules.

One of the foregoing objects is achieved in one aspect of the present invention through the provision of an information processing system including: a first information processing apparatus including: group information management means for managing information related to one or more groups each of which is formed of a plurality of shops; and accounting information storage means for storing the accounting information of a service which all shops included in the one or more groups can offer, and a second information processing apparatus comprising accounting information management means for setting or changing the accounting information of the service stored in the accounting information storage means.

In the information processing system, the group information management means may manage a combination of shops which can offer a certain service among the plurality of shops.

In the information processing system, the group information management means may manage at least one of the ID information of each group, the name of each group, the administrator of each group, the password of the administrator of each group, the ID information of all shops included in each group, the names of all the shops included in each group, the administrators of all the shops included in each group, and the password of the administrator of each shop.

In the information processing system, the group information management means may register, correct, and delete information related to the group.

In the information processing system, the group information management means may allow only the administrator of the information processing system to manage the information related to the group.

In the information processing system, the first information processing apparatus may report the processing performed by the use of the group information management means to the administrators of a group and a shop related to the processing.

In the information processing system, the accounting information management means may set or change the accounting information of a service which each group can offer and the accounting information of one or more products constituting the service.

In the information processing system, the accounting information management means may be able to set accounting information unique to a shop for a service which each group can offer.

In the information processing system, the accounting information management means may give priority to the accounting information of a service uniquely specified for a certain shop over the accounting information of a service which a group including the shop can offer.

In the information processing system, the accounting information management means may correct and delete the accounting information of the service and register the accounting information of a service which the group newly offers.

In the information processing system, the accounting information management means may allow the administrator of a certain group who manages the accounting information of a service which the group can offer or the administrator of a certain shop included in the group who manages the accounting information of a service which the shop can offer to set or change the accounting information of the service.

In the information processing system, the shop administrator may be able to set accounting information unique to the shop for a service which a certain group can offer, within a range allowed by the group administrator.

In the information processing system, the second information processing apparatus may report the setting and change made by the group administrator to the administrator of a shop included in the group which the group administrator manages.

In the information processing system, the second information processing apparatus may report the setting and change made by the shop administrator to the administrator of a group to which the shop which the shop administrator manages belongs.

In the information processing system, the accounting information of the service may be formed of a basic charge and an amount charge.

In the information processing system, the accounting information of the service may vary according to a period or an amount to be processed.

In the information processing system, a shop included in the group may be able to offer a service other than the service which all shops included in the group can offer.

In the information processing system, the service may be formed of one or more products.

In the information processing system, the service may make one or more prints of a certain image.

In the information processing system, the information processing system may include a local area network or the Internet.

In the information processing system, the first information processing apparatus may further includes service processing means for receiving an order of the service and processing the service.

One of the foregoing objects is achieved in another aspect of the present invention through the provision of an information processing apparatus including: group information management means for managing information related to one or more groups each of which is formed of a plurality of shops; and accounting information storage means for storing the accounting information of a service which all shops included in the one or more groups can offer.

One of the foregoing objects is achieved in still another aspect of the present invention through the provision of an information processing apparatus including: accounting information management means for setting or changing the accounting information of a service which all shops included in a certain group can offer; and control means for controlling such that the accounting information of the service, set or changed by the use of the accounting information management means is stored in an external unit.

One of the foregoing objects is achieved in yet another aspect of the present invention through the provision of an information processing method including the steps of: managing information related to one or more groups each of which is formed of a plurality of shops; storing the accounting information of a service which all shops included in the one or more groups can offer; and setting or changing the accounting information of the service which all the shops included in the one or more groups can offer.

One of the foregoing objects is achieved in a further aspect of the present invention through the provision of a computer readable storage medium storing a program, the program including the steps of: managing information related to one or more groups each of which is formed of a plurality of shops; storing the accounting information of a service which all shops included in the one or more groups can offer; and setting or changing the accounting information of the service which all the shops included in the one or more groups can offer.

One of the foregoing objects is achieved in a still further aspect of the present invention through the provision of an information processing system including: a first information processing apparatus comprising an order-issue means for ordering a certain service; and a second information processing apparatus including: accounting information storage means for storing the accounting information of a service which all shops included in one or more groups each of which is formed of a plurality of shops can offer; and charge calculation means for calculating the charge for a certain service ordered by the order-issue means, according to the accounting information stored in the accounting information storage means.

In the information processing system, the order-issue means may order the certain service from a certain shop included in the one or more groups.

In the information processing system, the second information processing apparatus may report the calculation result of the charge calculation means to the first information processing apparatus or a shop specified by the order-issue means.

In the information processing system, the certain service may be formed of one or more products.

In the information processing system, the charge calculation means may calculate the charge for the certain service according to the accounting information of one or more products constituting the certain service.

In the information processing system, the accounting information of the certain service may be formed of a basic charge and an amount charge.

In the information processing system, the accounting information of the certain service may vary according to a period or an amount to be processed.

In the information processing system, the certain service may make at least one or more prints of a certain image.

In the information processing system, the first information processing apparatus may be connected to the second information processing apparatus via a local area network or the Internet.

One of the foregoing objects is achieved in a yet further aspect of the present invention through the provision of an information processing apparatus including: accounting information storage means for storing the accounting information of a service which all shops included in one or more groups each of which is formed of a plurality of shops can offer; and charge calculation means for calculating the charge for a certain service according to the accounting information stored in the accounting information storage means.

One of the foregoing objects is achieved in an additional aspect of the present invention through the provision of an information processing method including the steps of: storing the accounting information of a service which all shops included in one or more groups each of which is formed of a plurality of shops can offer; and calculating the charge for a certain service according to the stored accounting information.

One of the foregoing objects is achieved in a still additional aspect of the present invention through the provision of a computer readable storage medium storing a program, the program including the steps of: storing the accounting information of a service which all shops included in one or more groups each of which is formed of a plurality of shops can offer; and calculating the charge for a certain service according to the stored accounting information.

One of the foregoing objects is achieved in a yet additional aspect of the present invention through the provision of an information processing system including: a first information processing apparatus including: accounting information storage means for storing the accounting information of a service which all shops included in one or more groups each of which is formed of a plurality of shops can offer; and authentication means for authenticating the operations of a certain administrator, and a second information processing apparatus comprising accounting information management means for managing the accounting information of a service which each group can offer, stored in the accounting information storage means, according to the authentication result of the authentication means.

In the information processing system, the accounting information storage means may store the accounting information of a service which all shops included in the one or more groups can offer, and the accounting information of one or more products constituting the service.

In the information processing system, the accounting information storage means may store the accounting information of a service which all shops included in the one or more groups can offer, and the accounting information unique to each shop of the service.

In the information processing system, the accounting information management means may manage the accounting information of a service which all shops included in each group can offer, and the accounting information of one or more products constituting the service.

In the information processing system, the accounting information management means may correct and delete a service which each group can offer, and register the accounting information of a service newly offered by the group.

The information processing system may be formed such that the authentication means authenticates the operations of the certain administrator and allows only the certain administrator to manage the accounting information of the service.

In the information processing system, the authentication means may allow a group administrator who manages the accounting information of a service which a certain group can offer, or the administrator of a certain shop included in each group who manages the accounting information of a service which the shop can offer to manage the accounting information of the service.

In the information processing system, the administrator of the shop may be able to set the accounting information unique to the shop of a service which a certain group can offer, within a range allowed by the group administrator.

In the information processing system, the second information processing apparatus may report the management performed by the group administrator to the administrator of a shop included in the group which the group administrator manages.

In the information processing system, the second information processing apparatus may report the management performed by the shop administrator to the administrator of the group to which the shop which the shop administrator manages belongs.

In the information processing system, the accounting information of the service may be formed of a basic charge and an amount charge.

In the information processing system, the accounting information of the service may vary according to a period or an amount to be processed.

In the information processing system, a shop included in the group may be able to offer a service other than a service which all shops included in the group can offer.

In the information processing system, the service may make one or more prints of a certain image.

In the information processing system, the information processing system may include a local area network or the Internet.

In the information processing system, the first information processing apparatus may further comprise charge calculation means for calculating the charge of a certain service according to the service accounting information stored in the accounting information storage means.

In the information processing system, when the accounting information unique to a shop included in the group is set, the charge calculation means may give priority to the accounting information unique to the shop over the accounting information of a service which the group can offer.

One of the foregoing objects is achieved in a supplementary aspect of the present invention through the provision of an information processing apparatus including: accounting information storage means for storing the accounting information of a service which all shops included in one or more groups each of which is formed of a plurality of shops can offer; and authentication means for authenticating the user who operates the accounting information of a service which each group can offer, stored in the accounting information storage means.

One of the foregoing objects is achieved in a still supplementary aspect of the present invention through the provision of an information processing apparatus including: accounting information management means for managing the accounting information of a service which a certain group can offer; and control means for controlling such that the accounting information of the service, updated by the use of the accounting information management means is stored in an external unit according to the authentication result of the user who operates the accounting information management means.

One of the foregoing objects is achieved in a yet supplementary aspect of the present invention through the provision of an information processing method including the steps of: storing the accounting information of a service which all shops included in one or more groups each of which is formed of a plurality of shops can offer; authenticating the operations of a certain administrator; and managing the accounting information of a service which each group can offer, according to the authentication result.

One of the foregoing objects is achieved in a yet still supplementary aspect of the present invention through the provision of a computer readable storage medium storing a program, the program including the steps of: storing the accounting information of a service which all shops included in one or more groups each of which is formed of a plurality of shops can offer; authenticating the operations of a certain administrator; and managing the accounting information of a service which each group can offer, according to the authentication result.

Other objects and other features of the present invention will be made clear by the following specification and the drawings.

### BRIEF DESCRIPTION OF THE DRAWINGS

FIG. 1 is a view showing an overall structure of a system according to an embodiment of the present invention.

FIG. 2 is a block diagram showing a system configuration example of each information processing apparatus in the system according to the embodiment of the present invention.

FIG. 3 is a block diagram showing a system configuration of a print server according to the embodiment of the present invention.

FIG. 4 is a structural view showing a module structure (program structure) according to the present embodiment.

FIG. 5 is a view showing a user table example according to the present embodiment.

FIG. 6 is a view showing an example of a user rank table according to the present embodiment.

FIG. 7 is a view showing an example of a user-and-user-rank relation table according to the present embodiment.

FIG. 8 is conceptual view showing printing-shop grouping according to the present embodiment.

FIG. 9 is a view showing a shop table example according to the present embodiment.

FIG. 10 is a view showing an example of a shop group table according to the present embodiment.

FIG. 11 is a view showing an example of a shop-and-shop-group relation table according to the present embodiment.

FIG. 12 is a view showing a service table example according to the present embodiment.

FIG. 13 is a view showing a product table example according to the present embodiment.

FIG. 14 is a conceptual view showing templates according to the present embodiment.

FIG. 15 is a view showing an example of a template table according to the present embodiment.

FIG. 16 is a view showing an example of a template-and-product relation table according to the present embodiment.

FIG. 17 is a view showing a price table example according to the present embodiment.

FIG. 18 is a structural view showing a printing order according to the present embodiment.

FIG. 19 is a flowchart showing a shop and shop group registration processing flow.

FIG. 20 is a flowchart showing a template and price registration processing flow.

FIG. 21 is a flowchart showing registration, correction, and deletion processing flows for each table.

FIG. 22 is a flowchart showing a printing-order-receive processing flow.

FIG. 23 is a view showing an example of a shop price table according to the present embodiment.

FIG. 24 is a flowchart showing price calculation processing for a printing shop.

FIG. 25 is a view showing an example of a price table for an ordered sheet count according to the present embodiment.

FIG. 26 is a flowchart showing price calculation processing for an ordered sheet count.

### DESCRIPTION OF THE PREFERRED EMBODIMENT

System Configuration

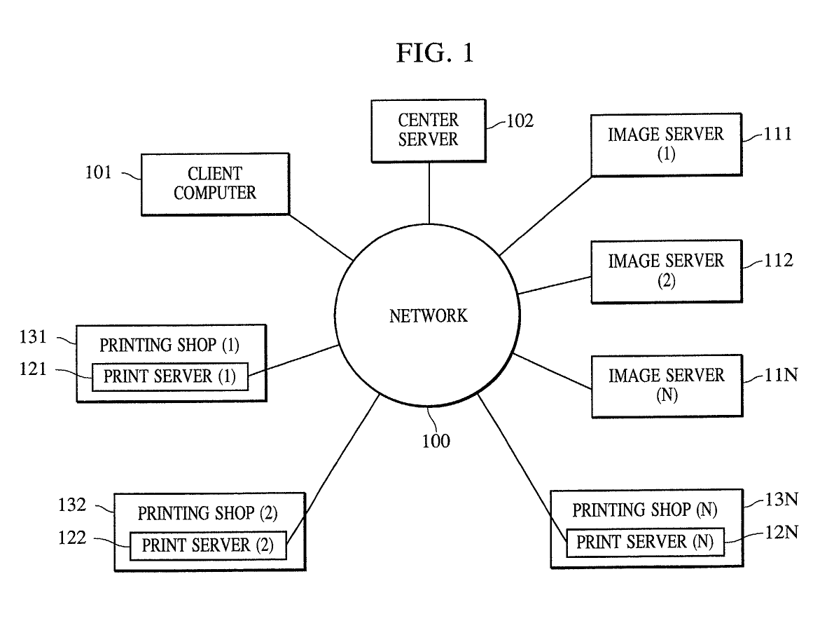

FIG. 1 is a structural view of the whole system used for describing an information processing system, an information processing apparatus, an information processing method, and a storage medium according to an embodiment of the present invention.

In FIG. 1, a connecting apparatus 100 represents a network, such as a local area network (LAN) or the Internet. The connecting apparatus 100 is hereinafter called just a network 100.

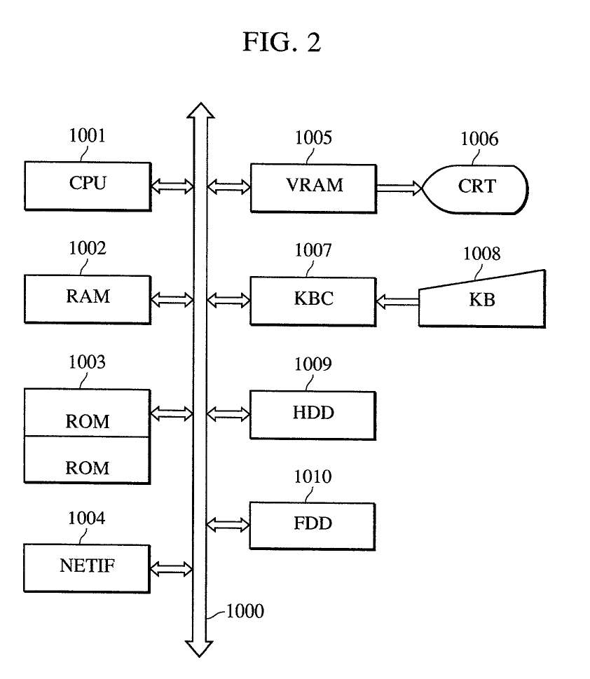

An information processing apparatus (a computer system, described later with FIG. 2, formed of a CPU, a ROM, a RAM, and an HDD) 101 is used by a customer who is a user of the system according to the present embodiment for direct operations from the home and is hereinafter called a client computer 101.

The client computer 101 has a reading function for reading the information (information in a printing shop, described later, and image information, for example) of a center server 102, described later, and an ordering function for ordering image printing from the center server 102.

The center server 102, which is called in that way in the present embodiment, is an information processing apparatus for processing a request from the client computer 101. As described later in detail, the center server 102 has a price calculation function, a storage function for storing an image to be transmitted to the client computer 101 according to a request from the client computer 101, and a function for receiving an image printing order sent from the client computer 101, obtaining the image according to image storage area information, and sending a printing order to print servers 121, 122, and 12N, described later.

Information processing apparatuses 111, 112, and 11N store images and transmit a stored image to the center server 102 according to a request from the center server 102. They are hereinafter called image servers.

The print servers 121, 122, and 12N are information processing apparatuses having a function for printing an image according to a printing order sent from the center server 102, a function for storing images for printing, and a function for transmitting a stored image according to a request from the center server 102 to the center server 102.

An image is printed according to an order sent from a customer and the printed image is passed to the customer in shops or parts of shops 131, 132, and 13N. These shops or the parts of shops are hereinafter called printing shops. A printing shop is formed of a print server and a shop computer.

The client computer 101, the center server 102, the image servers 111, 112, and 11N, and the print server 121, 122, and 12N are connected to each other through the network 100.

In FIG. 1, the client computer 101, the center server 102, the image servers 111, 112, and 11N, the print server 121, 122, and 12N, and the information processing apparatuses disposed at the printing shops 131, 132, and 13N are shown as separate bodies. Several information processing apparatuses can be physically replaced with one computer.

Block Diagram of the Client Computer, the Center Server, and the Image Servers

FIG. 2 is a block diagram showing a structure of each of the information processing apparatuses 101, 102, 111, 112, and 11N in the system according to the present embodiment.

In the system according to the present embodiment, since the computers other than the print servers 121, 122, and 12N, namely, the client computer 101, the center server 102, and the image servers 111, 112, and 11N have the same internal structure, the hardware structure of each information processing apparatus is collectively shown in FIG. 2.

In FIG. 2, a central processing unit (hereinafter called a CPU) 1001 controls the information processing apparatus.

A random access memory (hereinafter called a RAM) 1002 serves as a main memory of the CPU 1001 and also serves as an execution area for an executing program and a temporarily save area.

A read only memory (hereinafter called a ROM) section 1003 stores the operation procedure of the CPU 1001. The ROM section 1003 includes a program ROM which stores an operating system (OS) serving as a system program for controlling the information processing apparatus and a data ROM which stores information required for operating the whole system. Instead of the ROM section 1003, an HDD 1009, described later, may be used.

A network interface (NETIF) 1004 performs control of transferring data between information processing apparatuses through the network 100 and achieves diagnosis of a connection condition.

A video RAM (VRAM) 1005 develops an image showing the operating condition of the information processing apparatus, to be displayed on the screen of a display unit 1006 (hereinafter called a CRT) and controls the display.

A controller (KBC) 1007 controls an input signal sent from an external input unit 1008.

The external input unit (KB) 1008 receives an operation which the user performs for an information processing apparatus. The external input unit 1008 is formed of a keyboard or a pointing device, such as a mouse.

A hard disk drive (HDD) 1009 has a hard disk as a storage member, and stores application programs and data such as image information and registration information. The application programs in the system according to the present embodiment include a software program for reading through the network, used in the client computer, and a software program for registering shop information and a software program for receiving printing orders, both used in the center server.

An external input and output unit 1010 is formed, for example, of a floppy disk drive having a detachable floppy disk as a storage member or a CD-ROM drive having a detachable CD-ROM as a storage member. The external input and output unit 1010 is used for reading the application programs from external storage media such as a floppy disk and a CD-ROM, and hereinafter called an FDD.

Input and output buses (address bus, data bus and control bus) 1000 connect the above units.

Block Diagram of Print Server

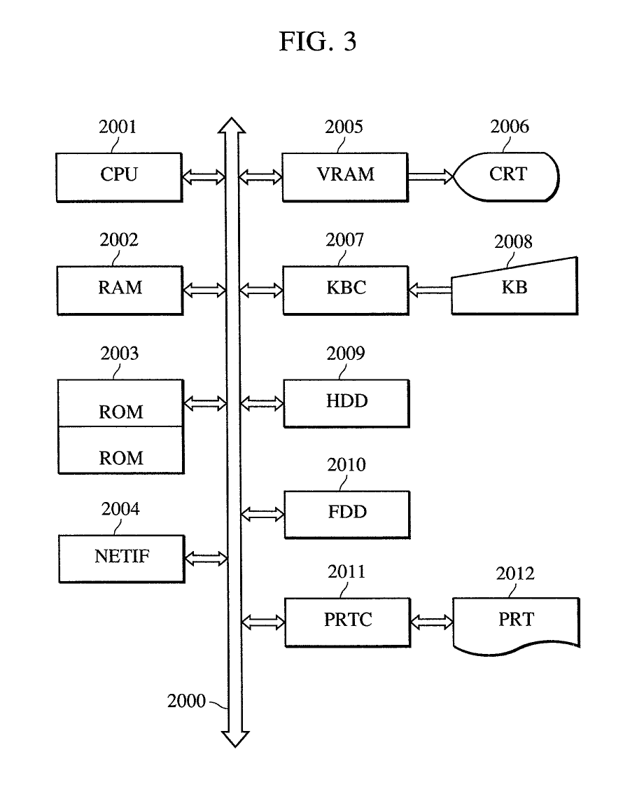

FIG. 3 is a block diagram showing a system structure of a print server according to the present embodiment. In FIG. 3, a CPU 2001 controls an information processing apparatus serving as a print server.

A RAM 2002 serves as a main memory of the CPU 2001 and also serves as an execution area for an executing software program and a temporarily save area.

A ROM section 2003 stores the operation procedure of the CPU 2001. The ROM section 2003 includes a program ROM which stores an operating system (OS) serving as a system program for controlling the print server and a data ROM which stores information required for operating the whole system. Instead of the ROM section 2003, an HDD 2009, described later, may be used.

A network interface (NETIF) 2004 performs control of transferring image data with the center server, the other print servers, and the image servers, and achieves diagnosis of a connection condition.

A video RAM (VRAM) 2005 develops an image showing the operating condition of the information processing apparatus serving as the print server, to be displayed on the screen of a display unit 2006 (hereinafter called a CRT) and controls the display.

A controller (KBC) 2007 controls an input signal sent from an external input unit 2008.

The external input unit (KB) 2008 receives an operation which the user performs for an information processing apparatus. The external input unit 2008 is formed of a keyboard or a pointing device, such as a mouse.

A hard disk drive (HDD) 2009 has a hard disk as a storage member, and stores image data and an application program for controlling printing.

An external input and output unit 2010 is formed, for example, of a floppy disk drive or a CD-ROM drive. The external input and output unit 2010 is used for reading the application program from external storage media such as a floppy disk and a CD-ROM, and hereinafter called an FDD.

A printer control unit 2011 controls an external output unit 2012 and an image to be output, and is hereinafter called a PRTC. The external output unit 2012 is formed, for example, of a printer. Input and output buses (address bus, data bus and control bus) 2000 connect the above units.

Module Structure of System

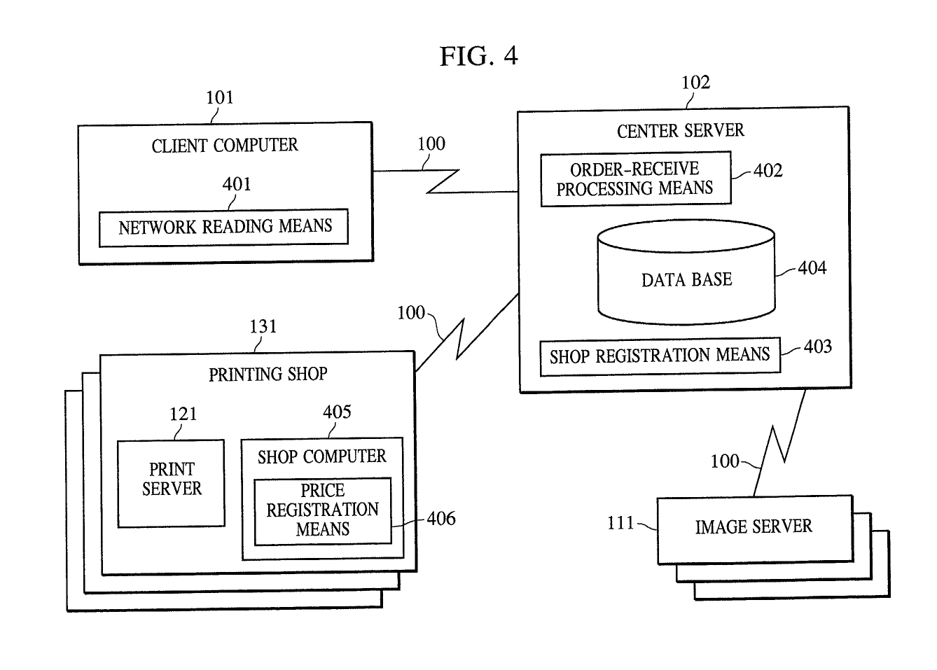

FIG. 4 is a structural view showing the module structure (program structure) of the system according to the present embodiment.

In FIG. 4, the client computer 101 stores network reading means 401 as a software program controlled under an operating system (OS) read from the ROM 1003, the HDD 1009, or the FDD 1010 and activated.

The network reading means 401 is stored in the ROM 1003, the HDD 1009, or the FDD 1010 of the client computer 101 and has a function formed of the software program developed in the RAM 1002 and used.

The network reading means 401 (namely, an application software program called an Internet browser) allows an external service to be received through the network 100, and performs processing for ordering image printing from the center server 102.

The center server 102 is on the network 100 and stores order-receive processing means 402, shop registration means 403, and a data base 404, described later, as programs controlled under the operating system (OS) read from the ROM 1003, the HDD 1009, or the FDD 1010 and activated.

The data base 404 is data storage means for storing data registered at the system according to the present embodiment, and is, for example, a relational data base system widely used in general or a retrievable file stored in the RAM 1002, the HDD 1009, or the FDD 1010.

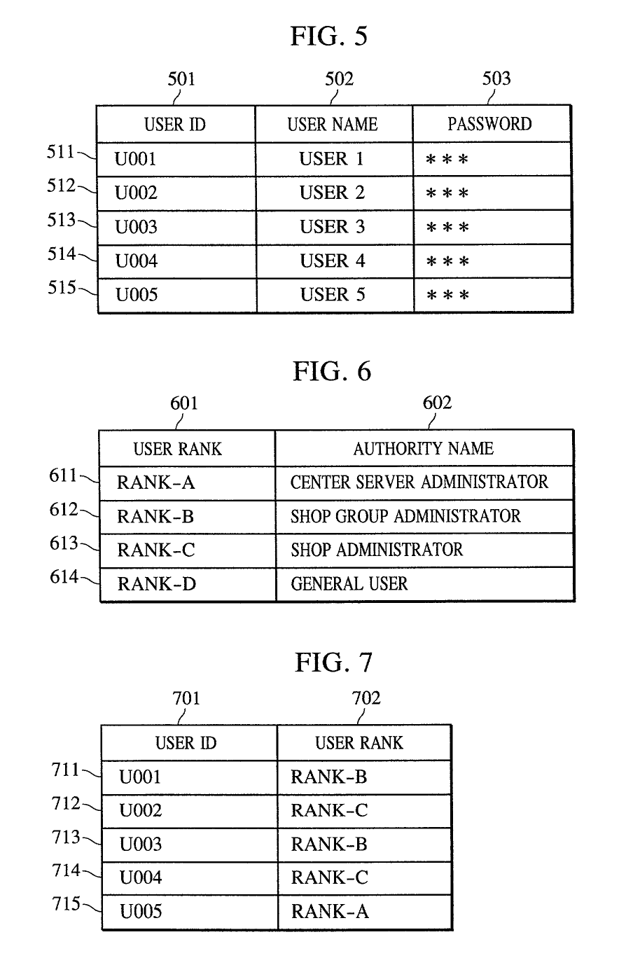

In the present embodiment, when price information is set at a plurality of printing shops, setting work is made efficient by grouping printing shops and using a template, described later. The data base 404 stores information mainly required therefor. A data structure will be described later by referring to FIG. 5 to FIG. 17.

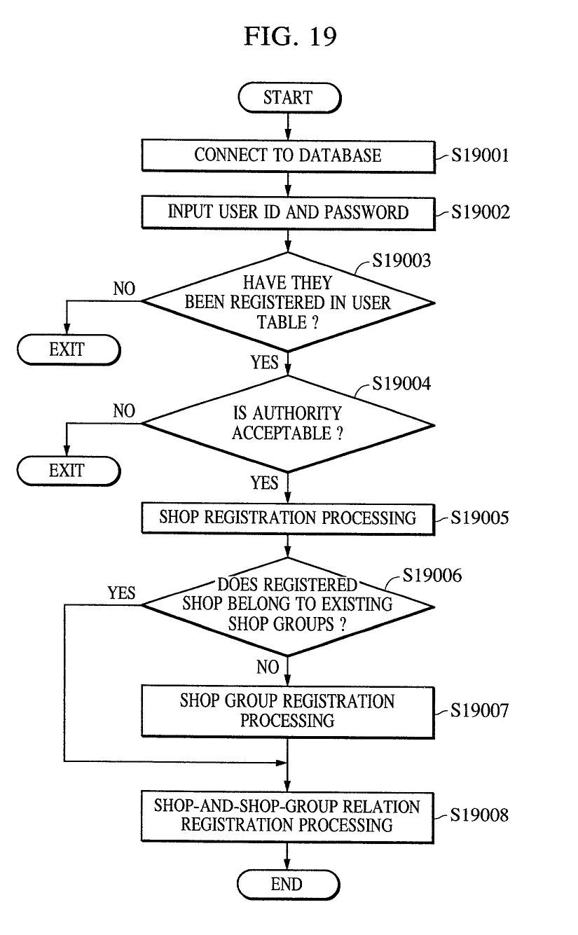

The shop registration means 403 is stored in the ROM 1003, the HDD 1009, or the FDD 1010 of the center server 102 and is an application program developed in the RAM 1002 and used. It is used for registration processing of shops and shop groups described later by referring to FIG. 19.

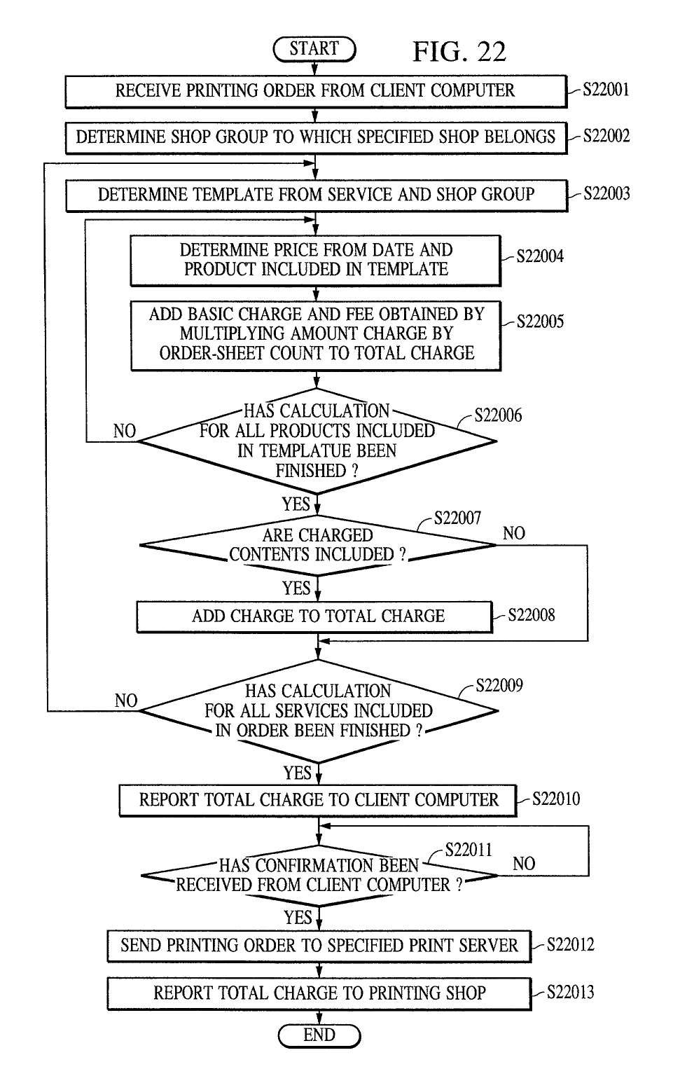

The order-receive processing means 402 is stored in the ROM 1003, the HDD 1009, or the FDD 1010 of the center server 102 and is an application program developed in the RAM 1002 and used. It is used for printing-order receive processing described later by referring to FIG. 22.

The printing shop 131 is formed of the print server 121 and a shop computer 405.

The print server 121 constitutes printing processing means and performs printing processing when it receives a request from the center server 102. The shop computer 405 is an information processing apparatus used in the printing shop 131 and stores price registration means 406, described later, as an application program controlled under the operating system (OS) read from the ROM 1003, the HDD 1009, or the FDD 1010 and activated.

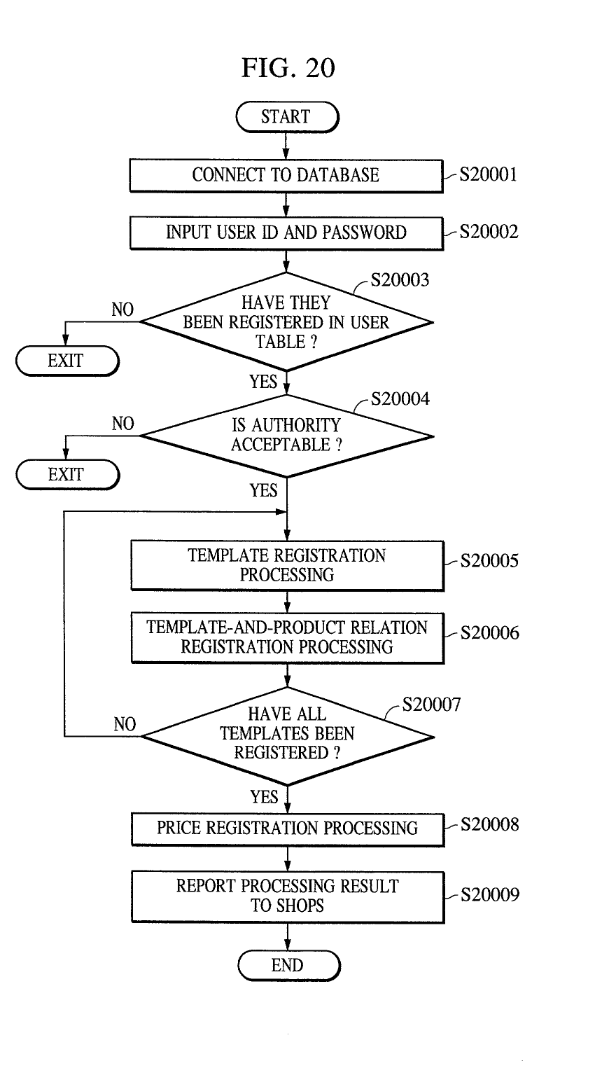

The price registration means 406 is stored in the ROM 1003, the HDD 1009, or the FDD 1010 of the shop computer 405 and is an application program developed in the RAM 1002 and used. It is used for template processing and price registration processing described later by referring to FIG. 20. One printing shop 131 or two or more printing shops 131 exist in the system according to the present embodiment. In FIG. 1, they are expressed as 131, 132, and 13N. In FIG. 4, there is no difference in contents to be described therebetween, only one printing shop 131 is described.

The image server 111 is image storage means for storing images for printing, and transmitting a stored image according to a request from the center server 102 to the center server 102.

One image server 111 or two or more image servers 111 exist in the system according to the present embodiment in the same way as for the printing shop 131. In FIG. 1, they are expressed as 111, 112, and 11N. In FIG. 4, there is no difference in contents to be described therebetween, only one image server 111 is described as a representation of a plurality of image servers.

The connection means 100 is a network such as a local area network (LAN) or the Internet, as described above. In the present embodiment, the client computer 101, the center server 102, the image server 111, the print server 121, and the shop computer 405 are shown as separate bodies. Several units of them can be physically replaced with one computer.

Data Structure in the Present Embodiment

A data structure required in the present embodiment will be described below by referring to FIG. 5 to FIG. 17. Data is, for example, stored in the data base 404 in the center server 102 in the present embodiment. Data management includes registration, maintenance, correction, and deletion.

FIG. 5 shows a user table used for uniquely identifying, for registration and management, operators (hereinafter called users) who perform data registration and management in the system in the present embodiment.

The user table includes user IDs 501 for uniquely expressing users in the system in the present embodiment, user names 502 for expressing the names of the users, and passwords 503 for protecting the authorities of the users.

Each row of the table corresponds to a data item registered at the user table. In FIG. 5, five data items 511, 512, 513, 514, and 515 have been registered.

FIG. 6 shows a user rank table used for ranking the scopes of the authorities in which the users manage the data. The user rank table includes user ranks 601 indicating the strengths of the authorities and authority names 602 indicating the names of the authorities.

In each row of the table shown in FIG. 6, the authority required in the system in the present embodiment is defined. There are shown the authority 611 of a center server administrator, the authority 612 of a shop group administrator, the authority 613 of a shop administrator, and the authority 614 of a general user.

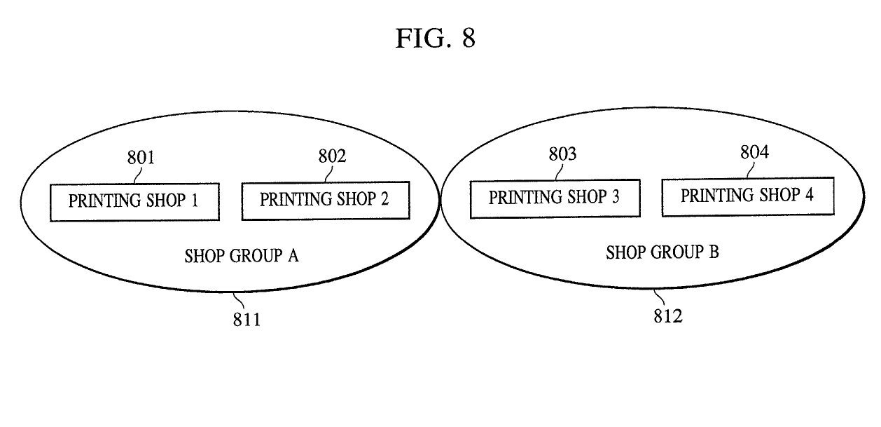

FIG. 7 shows a user-and-user-rank relation table which indicates the relationship between the users and the user ranks shown above. The user-and-user-rank relation table includes user IDs 701 in which the user IDs defined in the user table are registered and user ranks 702 in which the user ranks defined in the user rank table are registered.

Each row in the table shows a data item registered and managed at the user-and-user-rank relation table. In FIG. 7, five data items 711, 712, 713, 714, and 715 have been registered as examples.

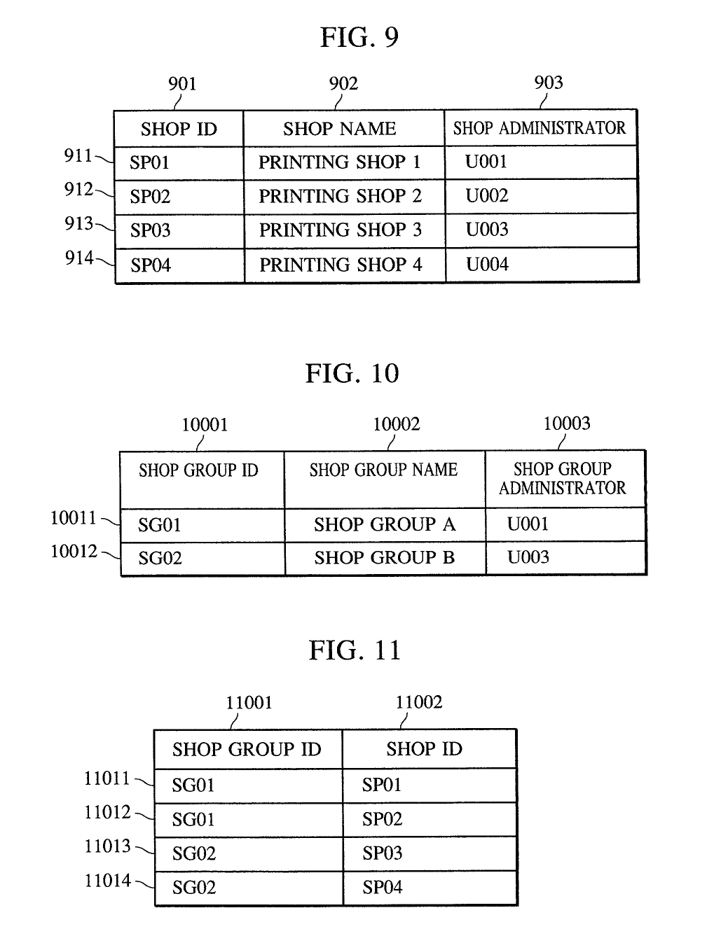

FIG. 8 is a conceptual view indicating printing-shop groups. This concept is implemented in the present embodiment by the use of tables shown in FIG. 9, FIG. 10, and FIG. 11.

In FIG. 8, there are shown printing shops 801, 802, 803, and 804 which are the same as those shown in FIG. 1 and FIG. 4, and shop groups 811 and 812, described later. A shop group is a collection member of printing shops, where price setting can be collectively performed. A printing shop registered in the system in the present embodiment need belong to any of shop groups defined in the system. The number of printing shops belonging a shop group can be any figure equal to or larger than zero.

FIG. 9 shows a shop table used for uniquely identifying printing shops for registration in the system in the present embodiment. The shop table includes shop IDs 901 for uniquely identifying printing shops in the system in the present embodiment, shop names 902 for expressing the names of the printing shops, and shop administrators 903 for expressing users who are in charge of shop management.

Each row of the table corresponds to a data item registered at the shop table. In FIG. 9, the printing shop 1, the printing shop 2, the printing shop 3, and the printing shop 4 shown in FIG. 8 have been registered as examples in rows 911, 912, 913, and 914, respectively. Their shop IDs are set to SP01, SP02, SP03, and SP04, respectively, and their shop administrators are set to U001, U002, U003, and U004, respectively.

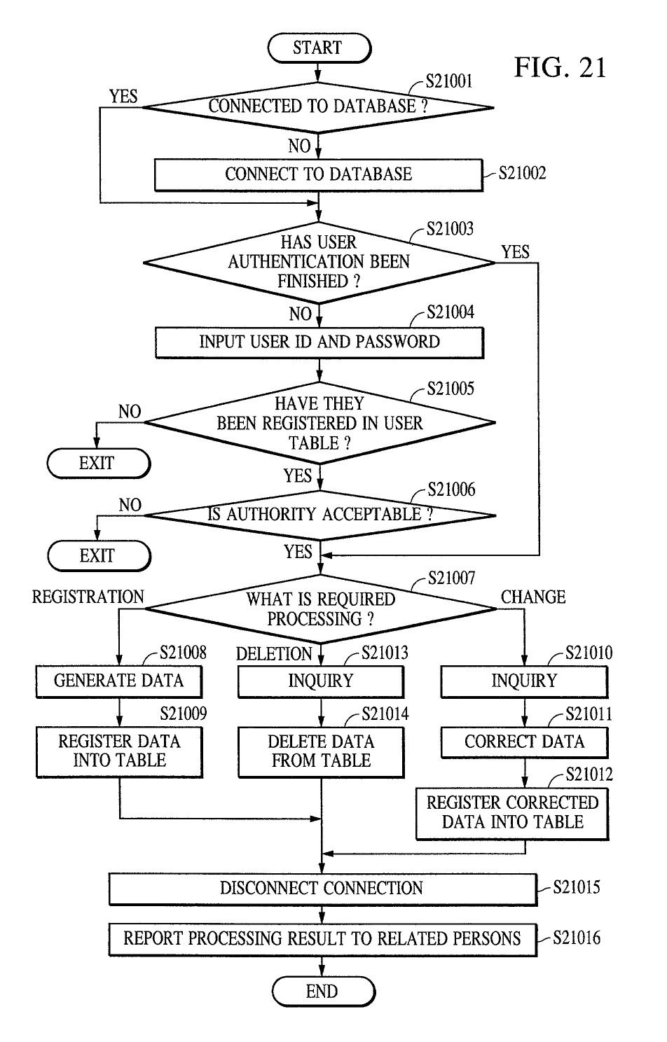

Only the user who has the authority of the center server administrator, described above by referring to FIG. 6, can register, correct, and delete the shop table in the present embodiment. A processing flow will be described later by referring to flowcharts shown in FIG. 19 and FIG. 21.

FIG. 10 shows a shop group table used for uniquely identifying shop groups for registration in the system in the present embodiment. The shop group table includes shop group IDs 10001 serving as identifications for uniquely identifying the shop groups in the present embodiment and shop group names 10002 indicating the names of the shop groups.

Each row in the table shows a data item registered at the shop group table. In FIG. 10, the shop group A and the shop group B shown in FIG. 8 have been registered in rows 10011 and 10012, respectively.

Only the user who has the authority of the center server administrator, described above by referring to FIG. 6, can register, correct, and delete the shop group table. A processing flow of registering, correcting, and deleting a shop group table will be described later by referring to the flowcharts shown in FIG. 19 and FIG. 21.

FIG. 11 shows a shop-and-shop-group relation table which indicates the relationship between the shops and the shop groups shown above. The shop-and-shop-group relation table includes shop group IDs 11001 in which the shop group IDs defined in the shop group table are registered and shops IDs 11002 in which the shop IDs defined in the shop table are registered.

Each row in the table shows a data item registered at the shop-and-shop-group relation table. FIG. 11 includes a data item 11011 in which the printing shop 1 is related to the shop group A as shown in FIG. 8, a data item 11012 in which the printing shop 2 is related to the shop group A as shown in FIG. 8, a data item 11013 in which the printing shop 3 is related to the shop group B as shown in FIG. 8, and a data item 11014 in which the printing shop 4 is related to the shop group B as shown in FIG. 8, as examples.

Only the user who has the authority of the center server administrator can register, correct, and delete the shop-and-shop-group relation table. A processing flow will be described later by referring to the flowcharts shown in FIG. 19 and FIG. 21.

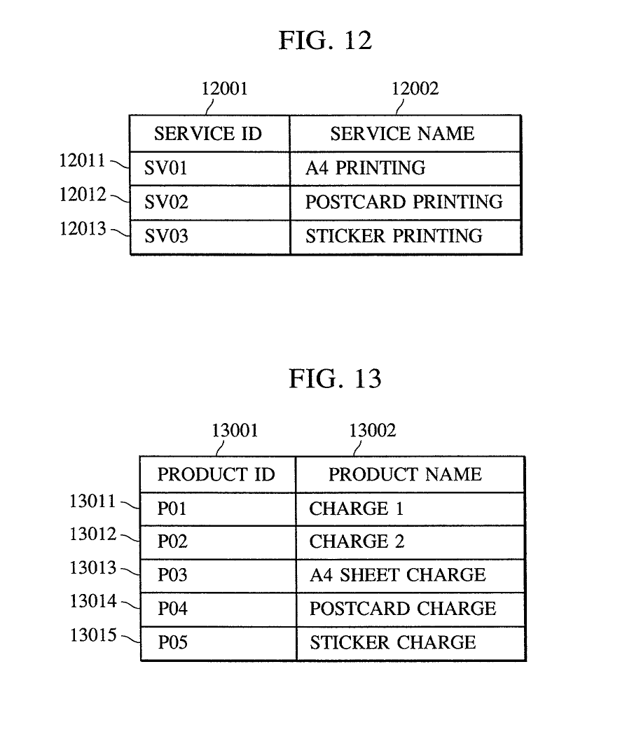

FIG. 12 shows a service table used for registering the types of printing services offered by the system in the present embodiment. The service table includes service IDs 12001 for uniquely identifying the types of the services in the system in the present embodiment, and service names 12002 for expressing the names of the services.

Each row of the table corresponds to a data item registered at the service table. In FIG. 12, three data items 12011, 12012, and 12013 have been registered as examples.

FIG. 13 shows a product table at which products required for the printing services offered by the system in the present embodiment are registered. The product table includes product IDs 13001 for uniquely identifying the types of products in the system in the present embodiment and product names 13002 indicating the names of the products.

Each row in the table shows a data item registered at the product table. In FIG. 13, five data items 13011, 13012, 13013, 13014, and 13015 have been registered as examples.

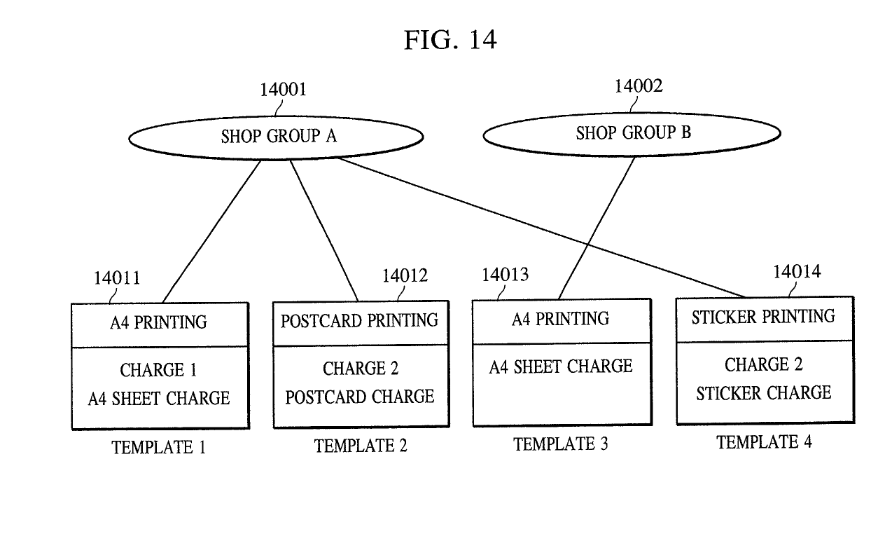

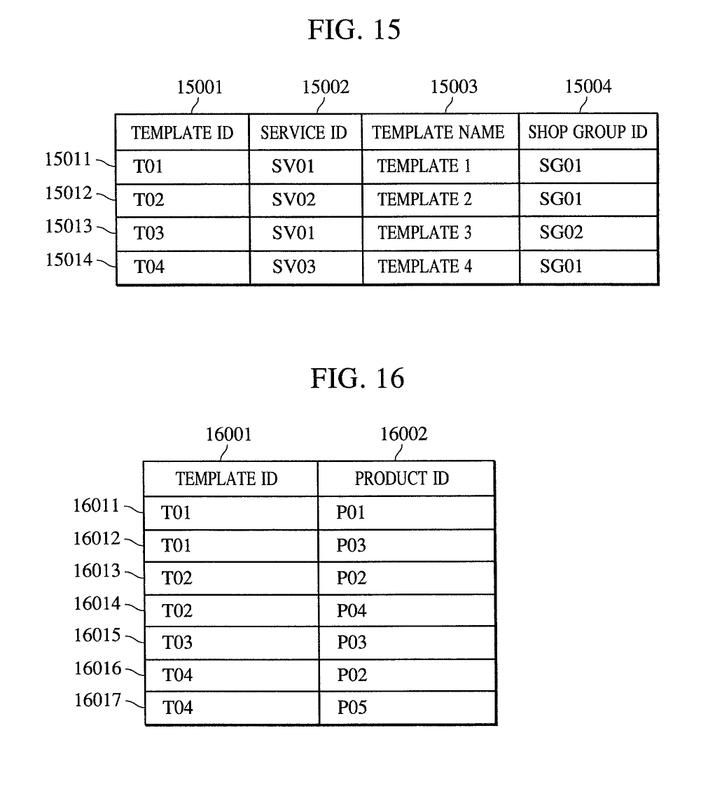

FIG. 14 is a conceptual view indicating a template in the system in the present embodiment. This concept is implemented in the present embodiment by the use of tables shown in FIG. 15 and FIG. 16.

A template in the system in the present embodiment shows the relationship between a service and a product required to offer the service, and is registered at the data base 404, which is a system module shown in FIG. 4.

In FIG. 14, the shop group 1 and the shop group B are indicated by 14001 and 14002 as examples. A template 1, indicated by 14011, shows that the A4 printing service includes a charge 1 and a A4 sheet charge.

In the same way, a template 2, indicated by 14012, shows that the postcard printing service includes a charge 2 and a postcard charge. A template 3, indicated by 14013, shows that the A4 printing service includes a A4 sheet charge only. A template 4, indicated by 14014, shows that the sticker printing service includes a charge 2 and a sticker charge.

A shop group administrator determines services to be offered and their product configurations for each shop group and registers them as a template. Any number (zero or more) of templates are registered and managed at a shop group. Registration processing flow will be described later by the use of flowcharts shown in FIG. 20 and FIG. 21.

In FIG. 14, the template 1, the template 2, and the template 4 are registered in the shop group A, 14001, and the template 3 is registered in the shop group B, 14002, as examples. With the use of templates in this way, the system in the present embodiment collectively manages shop groups having different price rules.

In FIG. 14, there are two A4 printing services as examples, the template 1, which includes the charge 1 and the A4 sheet charge and is registered in the shop group A, and the template 3, which includes the A4 sheet charge only and is registered in the shop group B.

FIG. 15 shows a template table used for uniquely identifying the above templates for registration in the system in the present embodiment, for relating the templates to services, and for setting template registration sources.

The template table includes template IDs 15011 for uniquely identifying the templates in the system in the present embodiment, service IDs 15002 for expressing the services corresponding to the templates, template names 15003 for expressing the names of the templates, and shop group IDs 15004 for indicating shop groups which have registered the templates.

Each row of the table corresponds to a data item registered at the template table. In FIG. 15, the template 1, the template 2, the template 3, and the template 4 shown in FIG. 14 as examples have been registered in rows 15011, 15012, 15013, and 15014, respectively. A user who has the authority of a shop group administrator, described above by referring to FIG. 6, can register, correct, and delete a template table. A processing flow will be described later by referring to flowcharts shown in FIG. 20 and FIG. 21.

FIG. 16 shows a template-and-product relation table used for relating products to templates. The template-and-product relation table includes template IDs 16001 in which the template IDs defined in the template table are registered and product IDs 16002 in which the product IDs defined in the product table are registered.

Each row in the table shows a data item registered at the template-and-product relation table. FIG. 16 includes a data item 16011 in which the charge 1 is related to the template 1 as shown in FIG. 14, a data item 16012 in which the A4 sheet charge is related to the template 1, a data item 16013 in which the charge 2 is related to the template 2, a data item 16014 in which the postcard charge is related to the template 2, a data item 16015 in which the A4 sheet charge is related to the template 3, a data item 16016 in which the charge 2 is related to the template 4, and a data item 16017 in which the sticker charge is related to the template 4, as examples.

A user who has the authority of a shop group administrator can register, correct, and delete a template-and-product relation table. A processing flow will be described later by referring to the flowcharts shown in FIG. 20 and FIG. 21.

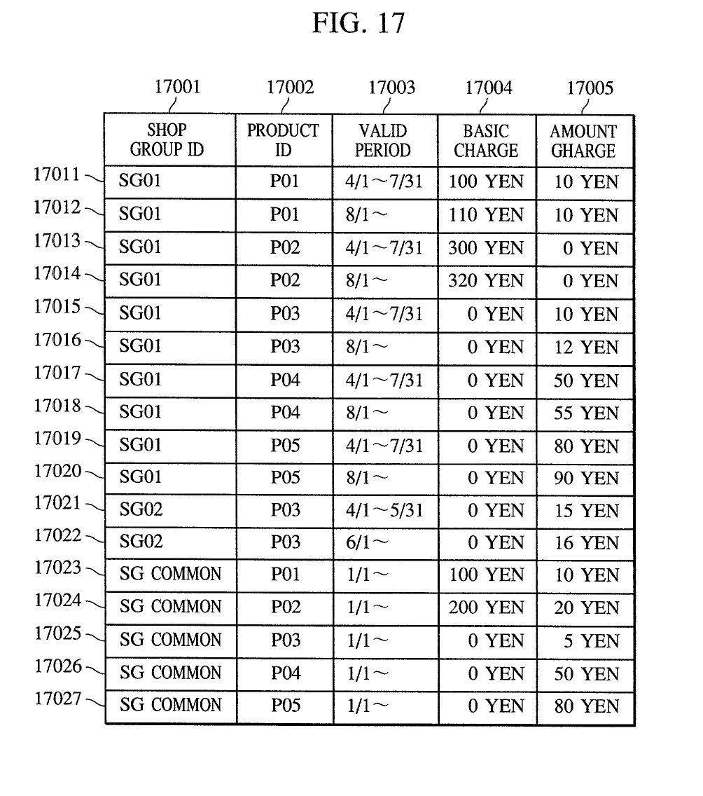

FIG. 17 is a price table used for registering and managing prices for shop groups, products, and valid periods. The price table includes shop group IDs 17001 for indicating shop groups at which prices are registered, product IDs 17002 for expressing products, valid periods 17003 for prices, basic charges 17004, and amount charges 17005.

The prices of all products included in all registered templates are registered for each shop group. A price is calculated by adding a basic charge 17004, which is evenly applied to an order irrespective of the ordered amount, to a fee obtained by multiplying an amount charge 17005, which is applied in proportion to the ordered amount, by the number of ordered sheets. For example, the price of an order in which five products each of which costs an amount charge of 10 yen are requested with a basic charge of 100 yen is obtained by an expression of 100 +10×5 =150 yen.

Each row in the price table corresponds to a data item registered at the table. In FIG. 17, the products defined in the template 1, the template 2, the template 3, and the template 4 shown in FIG. 14 are registered as data items.

For the shop group A, the prices of all the products included in the template 1, the template 2, and the template 4 registered for the shop group A, namely, the charge 1, the charge 2, the A4 sheet charge, the postcard charge, and the sticker charge, need to be registered for valid periods. In FIG. 17, these are expressed by data items of 17011, 17012, 17013, 17014, 17015, 17016, 17017, 17018, 17019, and 17020.

In the same way, for the shop group B, the price of the A4 sheet, which is a product included in the template 3 registered for the shop group B, needs to be registered for valid periods. In FIG. 17, it is expressed by data items of 17021 and 17022. A user who has the authority of a shop group administrator, described with FIG. 6, can register, correct, and delete the price table. A processing flow will be described later by referring to the flowcharts shown in FIG. 20 and FIG. 21.

In the system in the present embodiment, the center server administrator specifies standard prices in the system for a case in which the price of a product included in a template which a shop group offers is not set. In FIG. 17, data items 17023, 17024, 17025, 17026, and 17027 are registered with a code for identifying the data items as those common to the shop groups. A user having the authority of the center server administrator can register, correct, and delete a data item indicating a standard price in the system.

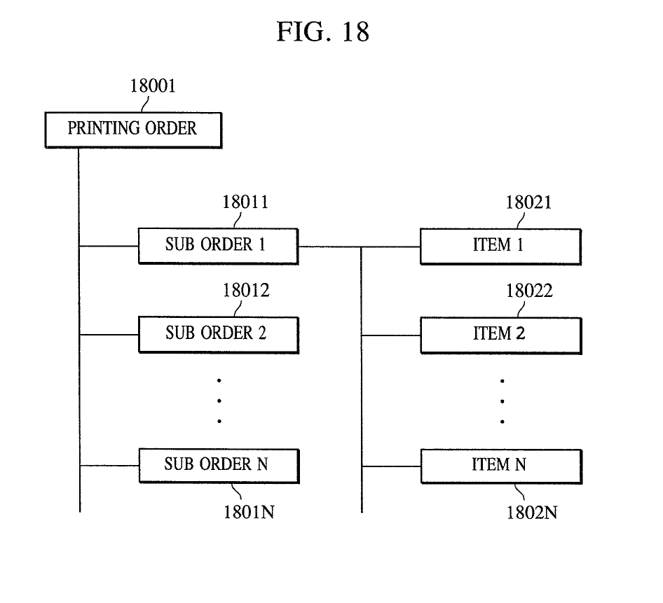

FIG. 18 is a view showing a printing-order structure in the system in the present embodiment.

In FIG. 18, a printing order 18001 serves as a unit of a printing request sent from the client computer and is identified by the unique order ID in the system. The printing order is formed of one or more sub orders 18011, 18012, . . . , and 1801N, and has the shop ID of the desired output printing shop.

The sub orders 18011, 18012, . . . , and 1801N are generated in units of services which a printing shop offers, and are identified by the sub order IDs which are unique within the upper-level order. Each sub order is formed of one or more order items 18021, 18022, . . . , and 1802N.

The order items 18021, 18022, . . . , and 1802N have editing information, such as an image ID uniquely issued in the system for identifying an image to be printed, and the information of a location where the image is to be printed on a sheet.

Data Registration Processing in the Present Embodiment

FIG. 19 is a flowchart showing a registration processing flow for shops and shop groups. This registration processing for shops and shop groups are performed with the use of the shop registration means 403, formed of a program stored in the center server 102, by operations of the center server administrator.

As shown in FIG. 19, when the processing is started, the data base 404 in the center server 102 is connected in a first step S19001.

In the next step S19002, the operator, namely, the center server administrator, is asked to input the user ID and the password.

In the next step S19003, the input user ID and the password are verified with the user table shown in FIG. 5 to check that the user ID has been positively registered and it is not abused. If an error is found, the processing is terminated.

When it is found from the determination in the step S19003 that the input user ID and the password have been authorized, the processing proceeds to a step S19004. The input user ID is verified with the user-and-user-rank relation table shown in FIG. 7. When it is found from the verification that the input user ID corresponds to the authority of the center server administrator, the processing proceeds to a step S19005 and a printing shop is registered in shop registration/correction processing described later. If an error is found, the processing is terminated.

In the next step S19006, it is determined whether the registered printing shop belongs to any of existing shop groups. When the registered printing shop is not related to the existing shop groups, a shop group is registered in a step S19007 by the use of shop-group registration/correction processing described later.

In the next step S19008, the relationship between the printing shops and the shop group is registered by the use of shop-and-shop-group relation registration processing described later.

FIG. 20 is a flowchart showing a template and price registration processing flow. This template and price registration processing are performed with the use of the price registration means 406, formed of a program stored in the shop computer 405, by operations of each shop group administrator.

When the processing is started, the data base 404 in the center server 102 is connected in a first step S20001.

In the next step S20002, the operator, namely, a shop group administrator, is asked to input the user ID and the password.

When the user ID and the password are input, they are verified with the user table shown in FIG. 5 in the next step S20003 to check that the user ID has been positively registered and it is not abused. If an error is found, the processing is terminated.

When an error is not found, the input user ID is verified with the user-and-user-rank relation table shown in FIG. 7 in the next step S20004 to check that the input user ID corresponds to the authority of a shop group administrator. If an error is found in this checking, the processing is terminated.

When the input user ID corresponds to the authority of a shop group administrator, a template is registered in a step S20005 in template registration/correction processing described later.

In the next step S20006, the template is related to a product by the use of template-and-product relation registration/correction processing described later.

In the next step S20007, it is checked whether all templates corresponding to all services which the shop group offers have been registered. If registration is insufficient, the processing goes back to the step S20005 and the above-described process is repeated.

When registration is complete, a price is registered in a step S20008 by the use of price registration/correction processing described later.

In the next step S20009, the registration and correction results are reported to the printing shops belonging to the shop group.

FIG. 21 is a flowchart showing registration, correction, and deletion processing for each table.

By the use of FIG. 21, a shop registration/correction processing flow, a shop-group registration/correction processing flow, a shop-and-shop-group relation registration/correction processing flow, a template registration/correction processing flow, a template-and-product relation registration/correction processing flow, and a price registration/correction processing flow will be described below.

Shop Registration/Correction Processing Flow

The shop registration/correction processing registers, corrects, and deletes data in the shop table stored in the data base 404 of the center server 102. This processing is performed with the use of the shop registration means 403 stored in the center server 102 by operations of the center server administrator, a shop group administrator, or a shop administrator.

The center server administrator has the authority of registering, correcting, and deleting all data items in the shop table. A shop group administrator has the authority of correcting a shop name and a shop administrator in the shop(s) belonging to the shop group administrated. A shop administrator has the authority of correcting a shop name in the shop administrated. The shop registration means 403 may be operated through the network 100 from an information processing apparatus other than the center server 102, such as the shop computer 405.

The processing procedure will be described below by referring to the flowchart shown in FIG. 21.

When the processing is started, it is determined in a first step S21001 whether the data base 404 of the center server 102 has been connected. If it is not yet connected, connection is made in a step S20002.

In the next step S21003, it is determined whether user authentication, described later, has been finished for the operator. If it has not yet been finished, user-authentication processing is performed in the following steps S21004, S21005, and S21006. In user authentication, whether the user ID exists, whether it is not abused, and whether the operator has the authority required for the corresponding processing are checked.

In the step S21004, the operator is asked to input the user ID and the password.

In the next step S21005, the input user ID and the password are verified with the user table shown in FIG. 5 and it is checked that the user ID positively exists and it is not abused. If an error is found, the processing is terminated.

In the next step S21006, the input user ID is verified with the user-and-user-rank relation table shown in FIG. 7 to check that the user ID corresponds to the authority of the center server administrator, a shop group administrator, or a shop administrator. If an error is found in this check, the processing is terminated. Otherwise, the processing proceeds to a step S21007.

In the step S21007, branch processing is performed according to the type of processing which the operator requires within the authority of the user ID. In registration processing, the processes of steps S21008 and S21009 are performed. In correction processing, the processes of steps S21010, S21011, and S21012 are performed. In deletion processing, the processes of steps S21013 and S21014 are performed.

In the step S21008 for registration processing, data required for registering a printing shop at the shop table is created.

In the next step S21009, the data created in the step S21008 is registered at the data base 404.

In the step S21010 for correction processing, printing-shop data to be corrected is inquired of the data base 404.

In the next step S21011, the data inquired in the step S21010 is corrected.

In the next step S21012, the corrected data is registered at the data base 404.

In the step S21013 for deletion processing, printing-shop data to be deleted is inquired of the data base 404.

In the next step S21014, the inquired data is deleted from the data base 404.

Next, in a step S21015, connection to the data base 404 is disconnected.

In the next step S21016, the processing results are reported to related persons.

The results of the processing performed by the center server administrator are reported to related shop group administrators and shop administrators. The results of the processing performed by a shop group administrator are reported to related shop administrators. The results of the processing performed by a shop administrator are reported to the shop group administrator.

Shop-Group Registration/Correction Processing Flow

The shop-group registration/correction processing registers, corrects, and deletes data in the shop group table stored in the data base 404 of the center server 102. This processing is performed with the use of the shop registration means 403 stored in the center server 102 by operations of the center server administrator or a shop group administrator.

The center server administrator has the authority of registering, correcting, and deleting all data items in the shop group table. A shop group administrator has the authority of correcting the shop group name for the shop group administrated. The shop registration means 403 may be operated through the network 100 from an information processing apparatus other than the center server 102, such as the shop computer 405.

It is determined in the step S21001 whether the data base 404 of the center server 102 has been connected. If it is not yet connected, connection is made in the step S20002.

In the next step S21003, it is determined whether user authentication has been finished for the operator. If it has not yet been finished, user-authentication processing is performed in the following steps S21004, S21005, and S21006.

In the step S21004, the operator is asked to input the user ID and the password.

In the next step S21005, the input user ID and the password are verified with the user table shown in FIG. 5 and it is checked that the user ID positively exists and it is not abused. If an error is found, the processing is terminated.

In the next step S21006, the input user ID is verified with the user-and-user-rank relation table shown in FIG. 7 to check that the user ID corresponds to the authority of the center server administrator or a shop group administrator. If an error is found in this check, the processing is terminated.

In the step S21007, branch processing is performed according to the type of processing which the operator requires within the authority of the user ID. In registration processing, the processes of the steps S21008 and S21009 are performed. In correction processing, the processes of the steps S21010, S21011, and S21012 are performed. In deletion processing, the processes of the steps S21013 and S21014 are performed.

In the step S21008, data required for registering a shop group at the shop group table is created.

In the next step S21009, the created data is registered at the data base 404.

In the step S21010, shop-group data to be corrected is inquired of the data base 404.

In the next step S21011, the inquired data is corrected.

In the next step S21012, the corrected data is registered at the data base 404.

In the step S21013, shop-group data to be deleted is inquired of the data base 404.

In the next step S21014, the inquired data is deleted from the data base 404.

Next, in the step S21015, connection to the data base 404 is disconnected.

In the next step S21016, the processing results are reported to the shop group administrators and the shop administrators.

Shop-and-Shop-Group Relation Registration/Correction Processing Flow

The shop-and-shop-group relation registration/correction processing registers, corrects, and deletes data in the shop-and-shop-group relation table stored in the data base 404 of the center server 102. This processing is performed with the use of the shop registration means 403 stored in the center server 102 by operations of the center server administrator.

It is determined in the first step S21001 whether the data base 404 of the center server 102 has been connected. If it is not yet connected, connection is made in the step S20002.

In the next step S21003, it is determined whether user authentication has been finished for the operator. If it has not yet been finished, user-authentication processing is performed in the following steps S21004, S21005, and S21006.

In the step S21004, the operator is asked to input the user ID and the password.

In the next step S21005, the input user ID and the password are verified with the user table shown in FIG. 5 and it is checked that the user ID positively exists and it is not abused. If an error is found, the processing is terminated.

In the next step S21006, the input user ID is verified with the user-and-user-rank relation table shown in FIG. 7 to check that the user ID corresponds to the authority of the center server administrator. If an error is found, the processing is terminated.

In the step S21007, branch processing is performed according to the type of processing which the operator requires. In registration processing, the processes of the steps S21008 and S21009 are performed. In correction processing, the processes of the steps S21010, S21011, and S21012 are performed. In deletion processing, the processes of the steps S21013 and S21014 are performed.

In the step S21008, data which relates a printing shop to a shop group is created.

In the next step S21009, the created data is registered at the data base 404.

In the step S21010, data to be corrected is inquired of the data base 404.

In the next step S21011, the inquired data is corrected.

In the next step S21012, the corrected data is registered at the data base 404.

In the step S21013, data to be deleted is inquired of the data base 404.

In the next step S21014, the inquired data is deleted from the data base 404.

Next, in the step S21015, connection to the data base 404 is disconnected.

In the next step S21016, the processing results are reported to the shop group administrators and the shop administrators.

Template Registration/Correction Processing Flow

The template registration/correction processing registers, corrects, and deletes data in the template table stored in the data base 404 of the center server 102. This processing is performed with the use of the price registration means 406 stored in the shop computer 405 by operations of a shop group administrator.

When the processing is started, it is determined in the step S21001 whether the data base 404 of the center server 102 has been connected. If it is not yet connected, connection is made in the step S20002.

In the next step S21003, it is determined whether user authentication has been finished for the operator. If it has not yet been finished, user-authentication processing is performed in the following steps S21004, S21005, and S21006.

In the step S21004, the operator is asked to input the user ID and the password.

In the next step S21005, the input user ID and the password are verified with the user table shown in FIG. 5 and it is checked that the user ID positively exists and it is not abused. If an error is found, the processing is terminated.

In the next step S21006, the input user ID is verified with the user-and-user-rank relation table shown in FIG. 7 to check that the user ID corresponds to the authority of a shop group administrator. If an error is found, the processing is terminated.

In the step S21007, branch processing is performed according to the type of processing which the operator to requires. In registration processing, the processes of the steps S21008 and S21009 are performed. In correction processing, the processes of the steps S21010, S21011, and S21012 are performed. In deletion processing, the processes of the steps S21013 and S21014 are performed.

In the step S21008 for registration processing, template data to be registered is created.

In the next step S21009, the data created in the step S21008 is registered at the data base 404.

In the step S21010 for correction processing, template data to be corrected is inquired of the data base 404.

In the next step S21011, the inquired data is corrected.

In the next step S21012, the corrected data is registered at the data base 404.

In the step S21013 for deletion processing, template data to be deleted is inquired of the data base 404.

In the next step S21014, the inquired data is deleted from the data base 404.

When the processing is finished, connection to the data base 404 is disconnected in the step S21015.

In the next step S21016, the processing results are reported to related shop administrators.

Template-and-Product Relation Registration/Correction Processing Flow

The template-and-product relation registration/correction processing registers, corrects, and deletes data in the template-and-product relation table stored in the data base 404 of the center server 102. This processing is performed with the use of the price registration means 406 stored in the shop computer 405 by operations of a shop group administrator.

The processing flow is the same as the template registration/correction processing flow, described above.

Price Registration/Correction Processing Flow

The price registration/correction processing registers, corrects, and deletes data in the price table stored in the data base 404 of the center server 102. This processing is performed with the use of the price registration means 406 stored in the shop computer 405 by operations of a shop group administrator. The processing flow is the same as the template registration/correction processing flow, described above.

Printing-Order-Receive Processing Flow

FIG. 22 is a flowchart showing a printing-order-receive processing flow. The printing-order-receive processing is performed by the order-receive processing means 402 stored in the center server 102 when the order-receive processing means 402 receives a printing request from the client computer 101. A printing request is sent in the form of a printing order shown in FIG. 18. The printing order includes one or more sub orders, which are generated in units of the types of services which a printing shop offers, and a combination information of a printing-shop designation and the number of sheets to be printed.

When the processing is started, the center server 102 receives a printing order from the client computer 101 in a first step S22001. The center server 102 assigns an order ID to the received printing order and stores the order ID into the data base 404 together with the user ID of the client computer, which is the transmission source.

In the next step S22002, the shop group to which the shop belongs is determined from the printing-shop information specified in the printing order.

In the next step S22003, a template is determined from the shop group determined in the step S22002 and the type of the service specified in the printing order.

In the next step S22004, a price table is searched by a product included in the template and the date when the printing order was issued, and price data is determined.

In the next step S22005, a subtotal is obtained by adding the basic charge to a fee calculated by multiplying the amount charge to the number of ordered sheets, and the subtotal is added to the total charge.

It is determined in the next step S22006 whether calculation for all products included in the template has been finished. If it has not yet been finished, the processing goes back to the step S22004 and the above-described process is repeated.

When it is determined in the step S22006 that calculation for all the products has been finished, the processing proceeds to a step S22007, and it is determined whether the image specified by the printing order is a charged image, described later.

A charged image refers to a copyrighted image, for which the user have to pay a use charge to the copyrighter before its use. When it is determined that it is a charged image, the charge is retrieved from the data base and added to the total charge in a step S22008.

It is determined in the next step S22009 whether calculation for all services included in the order has been finished. When the calculation has not yet been finished, the processing goes back to the step S22003 and the above process is repeated.

When it is determined in the step S22009 that calculation for all the services has been finished, the processing proceeds to a step S22010 and the total charge is reported to the client computer.

In the next step S22011, the center server awaits until it receives a confirmation of acceptance for the total charge from the client computer.

When the total charge is accepted, the printing order stored in the step S22001 is sent together with the user ID to the printing shop specified in the printing order in the next step S22012. The printing shop which receives the printing order performs printing according to the contents of the printing order.

In the next step S22013, the total charge is reported to the printing shop and all processing is finished.

Example of Price Calculation Processing

Price calculation processing is actually performed below as an example with the use of the sample data shown in FIG. 9 to FIG. 13 and FIG. 15 to FIG. 17 and the flowchart shown in FIG. 22.

Assume that a printing order was received on April 1 in the step S22001 of FIG. 22, in which A4 printing on five A4 sheets and postcard printing on 10 postcards were specified for the printing shop 1. The user ID which uniquely identifies the user of the client computer, the order ID which uniquely specifies the order, and the order itself are stored.

In the next step S22002, it is determined from the shop table shown in FIG. 9 that the shop ID of the printing shop 1 is SP01, and it is also determined from the shop-and-shop-group relation table that the ID of the shop group to which the printing shop 1 belongs is SG01. In addition, it is found from the shop group table shown in FIG. 10 that a shop group ID of SG01 corresponds to the shop group A.

In the step S22003, since the first service of the printing order is A4 printing, it is determined from the service table shown in FIG. 12 that the service ID is SV01, and since the shop group ID is SG01, it is also determined from the template table shown in FIG. 15 that the template ID is T01.

Next, in the step S22004, the template-and-product relation table shown in FIG. 16 is searched by the template ID T01 to determine that T01 is formed of product IDs of P01 and P03. The price table shown in FIG. 17 is searched by the printing-order date, April 1, and the ID, P01, of the first product to determine a basic charge of 100 yen and an amount charge of 10 yen.

In the next step S22005, a subtotal of 100 yen is added to 10 yen multiplied by 5 sheets to obtain a total charge of 150 yen.

In the next step S22006, it is determined whether calculation for all products has been finished. In the current case, since a template ID of T01 includes a product ID of P03, for which the price is not yet calculated, the processing goes back to the step S22004. In the step S22004, a basic charge of 0 yen and an amount charge of 10 yen are determined from the date, April 1, and a second product ID of P03.

In the next step S22005, a subtotal of 0 yen is added to 10 yen multiplied by 5 sheets to obtain a total of 200 yen.

In the next step S22006, it is determined that calculation for all the products included in a template ID of T01 has been finished.

In the next step S22007, it is determined whether a charged image is included. Assume that the order includes a charged image. In this case, the processing proceeds to a step S22008 and the charge of the charged image is added. Assuming that the charge of the charged image is 10 yen per sheet, for example, 10 yen multiplied by 5 sheets is added to obtain a total charge of 250 yen.

In the next step S22009, it is determined whether calculation for all services has been finished. Since the price of postcard printing, which is included in the services of the printing order, has not yet been calculated, the processing goes back to the step S22003.

In the step S22003, since the second service of the printing order is postcard printing and the printing shop belongs to the shop group A, it is determined that the second template is T02.

Next, in the step S22004, it is determined from the printing-order date, April 1, and a first product ID of P02 included in a template ID of T02 that a basic charge is 300 yen and an amount charge is 0 yen.

In the next step S22005, a subtotal of 300 yen is added to 0 yen multiplied by 10 sheets to obtain a total charge of 550 yen.

In the next step S22006, it is determined whether calculation for all products has been finished. In the current case, since a template ID of T02 includes a product ID of P04, for which the price is not yet calculated, the processing goes back to the step S22004.

In the step S22004, a basic charge of 0 yen and an amount charge of 50 yen are determined from the date, April 1, and a second product ID of P04. In the next step S22005, a subtotal of 0 yen is added to 50 yen multiplied by 10 sheets to obtain a total charge of 1050 yen.

In the next step S22006, it is determined that calculation for all the products included in a template ID of T02 has been finished.

In the next step S22007, it is determined whether a charged image is included. Assuming that the order does not include a charged image, the processing proceeds to a step S22009.

In the step S22009, it is determined that calculation for all the services included in the order has been finished.

In the next step S22010, a total charge of 1050 yen is reported to the client computer.

In the next step S22011, the center server awaits until the confirmation of acceptance of the total charge is sent from the client computer.

In the next step S22012, the printing order stored in the step S22001 is sent together with the user ID to the printing shop specified in the printing order. The printing shop which receives the printing order performs printing according to the contents of the printing order.

In the next step S22013, the total charge is reported to the printing shop.

Price Registration and Price Calculation Processing for each Printing Shop

Price registration and price calculation processing for each printing shop is a variation of the printing-order-receive processing, described by referring to FIG. 22, in the system in the present embodiment. A processing flow for setting independent prices in a printing shop will be described.

In the system in the present embodiment, a shop group administrator collectively specifies a price table in order to apply it to all printing shops in the group. The shop group administrator or a shop administrator may further specify prices for each printing shop. The price registration and price calculation processing for each printing shop is, for example, used for price settings corresponding to a special sale in a particular printing shop for a limited period.

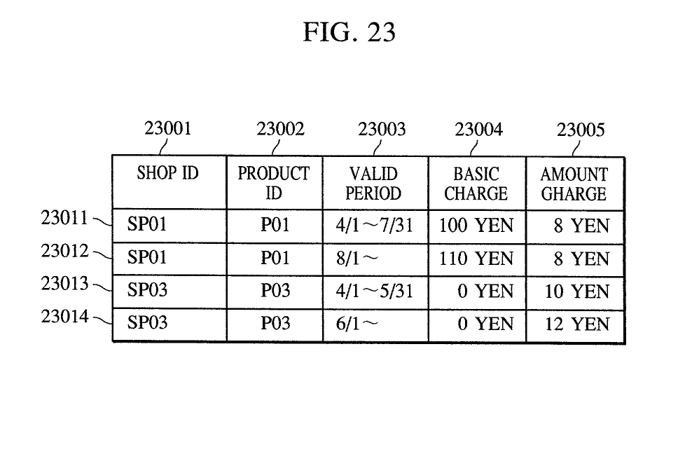

FIG. 23 is a shop price table indicating prices for each printing shop. It has a format in which the shop group ID row in the price table described by referring to FIG. 17 is replaced with a shop ID, and includes shop IDs 23001, product IDs 23002, valid periods 23003, basic charges 23004, and amount charges 23005.

Each row in the price table corresponds to a price data item registered for a printing shop. In FIG. 23, four data items 23011, 23012, 23013, and 23014 are registered as examples.

The price registration processing for each printing shop is performed by a shop group administrator or a shop administrator who is allowed by the shop group administrator after the template and price registration processing for each printing shop shown in FIG. 20 is finished. In the system in the present embodiment, when the shop group administrator allows a shop administrator to perform this operation, a limited range of correction for price settings may be specified.

The price registration processing for each printing shop registers data at the shop price table stored in the data base 404 of the center server 102. This processing is performed with the use of the price registration means 406 stored in the shop computer 405 by operations of a shop group administrator or a shop administrator. A registration processing flow will be described below by referring to the flowchart shown in FIG. 21.

When the processing is started, it is determined in the step S21001 whether the data base 404 of the center server 102 has been connected. If it is not yet connected, connection is made in the step S20002.

In the next step S21003, it is determined whether user authentication has been finished for the operator. If it has not yet been finished, user-authentication processing is performed in the following steps S21004, S21005, and S21006.

In the step S21004, the operator is asked to input the user ID and the password.

In the next step S21005, the input user ID and the password are verified with the user table shown in FIG. 5 and it is checked that the user ID positively exists and it is not abused. If an error is found, the processing is terminated.

In the next step S21006, the input user ID is verified with the user-and-user-rank relation table shown in FIG. 7 to check that the user ID corresponds to the authority of a shop group administrator or a shop administrator. If an error is found, the processing is terminated.

In the step S21007, branch processing is performed according to the type of processing which the operator requires. In registration processing, the processes of the steps S21008 and S21009 are performed. In correction processing, the processes of the steps S21010, S21011, and S21012 are performed. In deletion processing, the processes of the steps S21013 and S21014 are performed.

In the step S21008 for registration processing, price data for a printing shop is created. When a shop administrator performs this processing, whether the operation is allowed and whether a set price falls in the allowed limited range are checked. If the operation is not allowed, the processing is terminated. If a set price exceeds the allowed limited range, an alarm is issued so as to remind the operator to set a price within the limited range.

In the next step S21009, the created data is registered at the data base 404.

In the step S21010 for correction processing, data to be corrected is inquired of the data base 404.

In the next step S21011, the inquired data is corrected. When a shop administrator performs this processing, whether the operation is allowed and whether a set price falls in the allowed limited range are checked. If the operation is not allowed, the processing is terminated. If a set price exceeds the allowed limited range, an alarm is issued so as to remind the operator to set a price within the limited range.

In the next step S21012, the corrected data is registered at the data base 404.

In the step S21013 for deletion processing, data to be deleted is inquired of the data base 404.

In the next step S21014, when the operator is a shop administrator, whether the operation is allowed is checked. If the operation is not allowed, the processing is terminated. Otherwise, the inquired data is deleted from the data base 404.

When the above processing is finished, connection to the data base 404 is disconnected in the step S21015.

In the next step S21016, the processing results are reported to related persons.

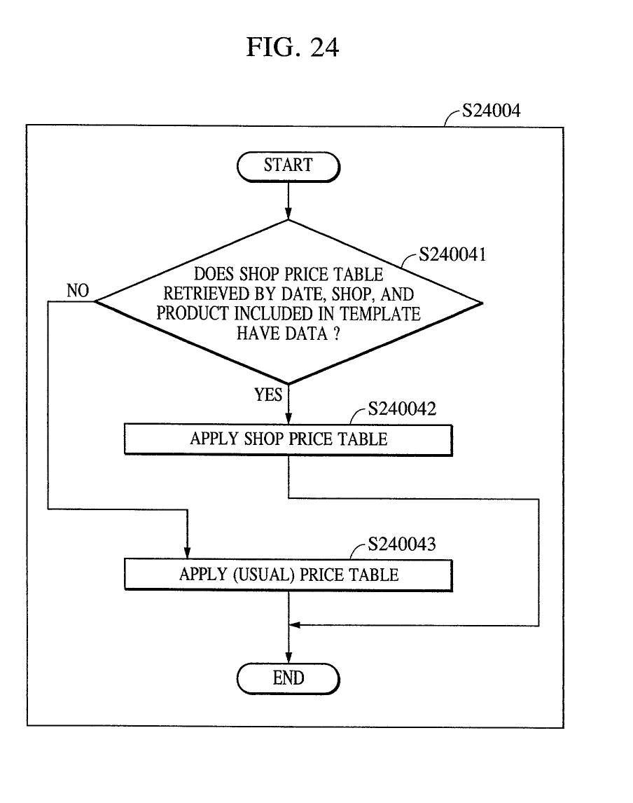

FIG. 24 is a flowchart showing a price calculation processing for a printing shop. In FIG. 24, a step S24004 indicates the contents of a process to be performed instead of the price calculation processing step S22004 shown in FIG. 22.

When the price calculation processing for a printing shop is started, the shop price table is searched by the date when the printing order is issued, a shop ID, and a product ID included in a template to check whether data exists, in a first step S240041.

When it is found in this checking that data exists, the processing proceeds to a step S240042 to apply the data in the shop price table.

When it is found in the checking of the step S240041 that data does not exist, the processing proceeds to a step S240043 to apply data in the price table registered for each shop group.

Price Registration and Price Calculation Processing for the Number or Ordered Sheets

Price registration and price calculation processing for the number of ordered sheets is a variation of the printing-order-receive processing, described by referring to FIG. 22, in the system in the present embodiment. A processing flow for setting a price for the number of ordered sheets will be described. This price registration and price calculation processing for the number of ordered sheets is used for price settings in a case in which discount is applied as the number of ordered sheets increases.

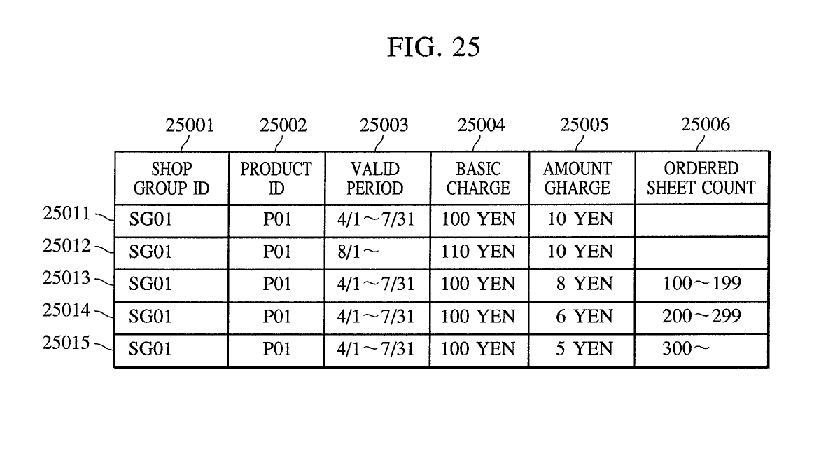

FIG. 25 is a price table indicating prices for the numbers of ordered sheets. The price table described by referring to FIG. 17 is extended so that data can be registered for the numbers of ordered sheets. The price table shown in FIG. 25 includes shop IDs 25001, product IDs 25002, valid periods 25003, basic charges 25004, amount charges 25005, and ordered sheet counts 25006.

Each row in the price table corresponds to a price data item registered for an ordered sheet count. In FIG. 25, four data items 25011, 25012, 25013, and 25014 are registered as examples.

The data item 25013 shows charges for an ordered-sheet-count range of 100 to 199, the data item 25014 shows charges for an ordered-sheet-count range of 200 to 299, and the data item 25015 shows charges for an ordered-sheet-count range of 300 or more. The data items 25011 and 25012 have blank ordered-sheet-count cells, and show out of a set-sheet-count range and no sheet count setting, respectively.

The price registration processing for an ordered sheet count is performed by a shop group administrator after the template and price registration processing for each printing shop shown in FIG. 20 is finished. The price registration processing for an ordered sheet count registers data at the shop price table stored in the data base 404 of the center server 102. This processing is performed with the use of the price registration means 406 stored in the shop computer 405 by operations of the shop group administrator. A registration processing flow will be described below by referring to the flowchart shown in FIG. 21.

When the price registration processing for an ordered sheet count is started, it is determined in the first step S21001 whether the data base 404 of the center server 102 has been connected. If it is not yet connected, connection is made in the step S20002.

In the next step S21003, it is determined whether user authentication has been finished for the operator. If it has not yet been finished, user-authentication processing is performed in the following steps S21004, S21005, and S21006.

More specifically, in the step S21004, the operator is asked to input the user ID and the password.

In the next step S21005, the input user ID and the password are verified with the user table shown in FIG. 5 and it is checked that the user ID positively exists and it is not abused. If an error is found, the processing is terminated.

In the next step S21006, the input user ID is verified with the user-and-user-rank relation table shown in FIG. 7 to check that the user ID corresponds to the authority of a shop group administrator. If an error is found, the processing is terminated.

When it is determined in the step S21006 that the operator has the authority of a shop group administrator, the processing proceeds to the step S21007. In the step S21007, branch processing is performed according to the type of processing which the operator requires. In registration processing, the processes of the steps S21008 and S21009 are performed. In correction processing, the processes of the steps S21010, S21011, and S21012 are performed. In deletion processing, the processes of the steps S21013 and S21014 are performed.

In the step S21008 for registration processing, price data for an ordered sheet count is created.

In the next step S21009, the created data is registered at the data base 404.

In the step S21010, data to be corrected is inquired of the data base 404.

In the next step S21011 for correction processing, the inquired data is corrected.

In the next step S21012, the corrected data is registered at the data base 404.

In the step S21013 for deletion processing, data to be deleted is inquired of the data base 404.

In the next step S21014, the inquired data is deleted from the data base 404.

When the above processing is finished, connection to the data base 404 is disconnected in the step S21015.

In the next step S21016, the processing results are reported to related shop administrators and all processing is finished.

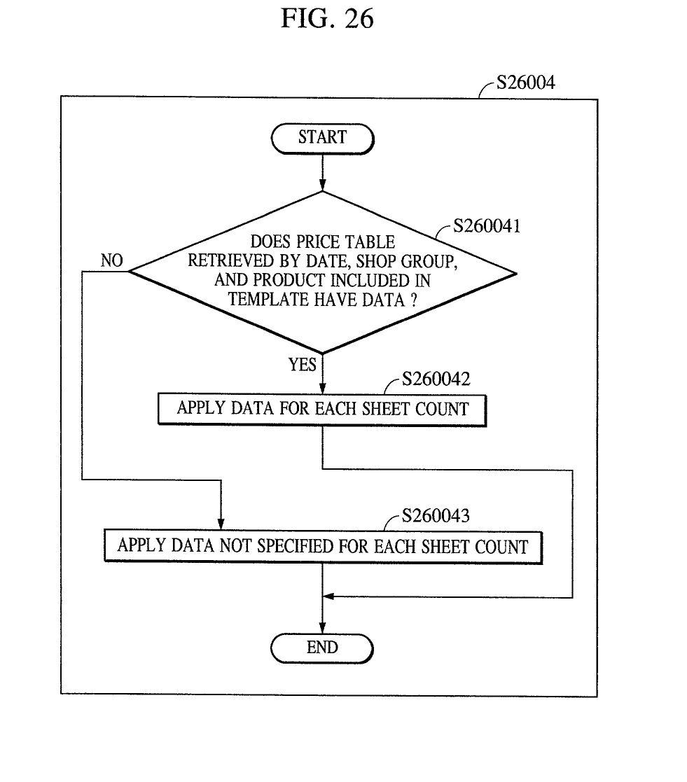

FIG. 26 is a flowchart showing a price calculation processing for an ordered sheet count. In FIG. 26, a step S26004 is performed instead of the price calculation processing step S22004 shown in FIG. 22.

In a first step S260041, the price table is searched by the date when the printing order is issued, a shop group ID, an ordered sheet count, and a product ID included in a template to check whether data exists.

When it is found in this checking that data exists, the processing proceeds to a step S260042 to apply the data registered for an ordered sheet count.

When data does not exist, data which is not specified for an ordered sheet count is applied in a step S260043.

The processing shown in the present embodiment is mainly performed by the CPU 1001 with the use of each function means formed of a program stored in the program ROM 1003. For one or more groups each of which is formed of a plurality of shops, the accounting information of services which all shops included in the group(s) can offer is stored in the RAM 1002. A program for implementing a function of calculating a charge for a certain service according to the accounting information is stored in the program ROM 1003.

The above program is not necessarily stored in the ROM 1003. It may be stored in an external memory card. In other words, the objects of the present invention are also achieved in a configuration in which a storage medium storing the program code of software which implements the function described above in the present embodiment is supplied to a system or an apparatus and an information processing unit (or CPU) of the system or the apparatus reads the program code stored in the storage medium and executes it.

In this case, since the program code itself read from the storage medium implements the function described in the present embodiment, the storage medium storing the program code is a part of the present invention.

As storage media for supplying the program code, floppy disks, hard disks, optical disks, magneto-optical disks, CD-ROMs, CD-Rs, magnetic tapes, nonvolatile memory cards, ROMs, and DVDs are used.

In addition to a case in which the program code read by the computer is executed to implement the function described in the present embodiment, the present invention includes a case in which an operating system (OS) running on an information processing apparatus performs a part or the whole of actual processing according to the designation of the program code and the function described in the present embodiment is implemented by the processing.

The present invention also includes a case in which the program code read from a storage medium is written into a memory provided for a function extension board inserted into an information processing apparatus or a function extension unit connected to an information processing apparatus, the CPU provided for the function extension board or the function extension unit performs a part or the whole of actual processing according to the designation of the program code, and the function described in the present embodiment is implemented by the processing.

As described above, according to the embodiment of the present invention, the accounting information of the services which each of a plurality of shops having different price rules can offer is easily, flexibly, and collectively managed.

In addition, according to the present invention, the accounting information of a shop(s) which can offer a certain service among a plurality of shops having different price rules is collectively or independently specified or changed.

What is claimed is:

1. An information processing system comprising:
a first information processing apparatus comprising:
group information management means for managing information related to one or more groups each of which is formed of a plurality of shops; and
accounting information storage means for storing the accounting information of a service which all shops included in the one or more groups can offer, and
a second information processing apparatus comprising accounting information management means for setting or changing the accounting information of the service stored in said accounting information storage means.

2. An information processing system according to claim 1, wherein said group information management means manages a combination of shops which can offer a certain service among the plurality of shops.

3. An information processing system according to claim 1, wherein said group information management means manages at least one of the ID information of each group, the name of each group, the administrator of each group, the password of the administrator of each group, the ID information of all shops included in each group, the names of all the shops included in each group, the administrators of all the shops included in each group, and the password of the administrator of each shop.

4. An information processing system according to claim 3, wherein said group information management means registers, corrects, and deletes information related to the group.

5. An information processing system according to claim 4, wherein said group information management means allows only the administrator of the information processing system to manage the information related to the group.

6. An information processing system according to claim 1, wherein said first information processing apparatus reports the processing performed by the use of said group information management means to the administrators of a group and a shop related to the processing.

7. An information processing system according to claim 1, wherein said accounting information management means sets or changes the a counting information of a service which each group can offer and the accounting information of one or more products constituting the service.

8. An information processing system according to claim 1, wherein said accounting information management means can set accounting information unique to a shop for a service which each group can offer.

9. An information processing system according to claim 8, wherein said accounting information management means gives priority to the accounting information of a service uniquely specified for a certain shop over the accounting information of a service which a group including the shop can offer.

10. An information processing system according to claim 1, wherein said accounting information management means corrects and deletes the accounting information of the service and registers the accounting information of a service which the group newly offers.

11. An information processing system according to claim 1, wherein said accounting information management means allows the administrator of a certain group who manages the accounting information of a service which the group can offer or the administrator of a certain shop included in the group who manages the accounting information of a service which the shop can offer to set or change the accounting information of the service.

12. An information processing system according to claim 11, wherein the shop administrator can set accounting information unique to the shop for a service which a certain group can offer, within a range allowed by the group administrator.

13. An information processing system according to claim 1, wherein said second information processing apparatus reports the setting and change made by the group administrator to the administrator of a shop included in the group which the group administrator manages.

14. An information processing system according to claim 12, wherein said second information processing apparatus reports the setting and change made by the shop administrator to the administrator of a group to which the shop which the shop administrator manages belongs.

15. An information processing system according to claim 1, wherein the accounting information of the service is formed of a basic charge and an amount charge.

16. An information processing system according to claim 1, wherein the accounting information of the service varies according to a period or an amount to be processed.

17. An information processing system according to claim 1, wherein a shop included in the group can offer a service other than the service which all shops included in the group can offer.

18. An information processing system according to claim 1, wherein the service is formed of one or more products.

19. An information processing system according to claim 1, wherein the service makes one or more prints of a certain image.

20. An information processing system according to claim 1, wherein said information processing system includes a local area network or the Internet.

21. An information processing system according to claim 1, wherein said first information processing apparatus further comprises service processing means for receiving an order of the service and processing the service.

22. An information processing apparatus comprising:
group information management means for managing information related to one or more groups each of which is formed of a plurality of shops; and
accounting information storage means for storing the accounting information of a service which all shops included in the one or more groups can offer.

23. An information processing apparatus comprising:
accounting information management means for setting or changing the accounting information of a service which all shops included in a certain group can offer; and
control means for controlling such that the accounting information of the service, set or changed by the use of said accounting information management means is stored in an external unit.

24. An information processing method comprising the steps of:
managing information related to one or more groups each of which is formed of a plurality of shops;
storing the accounting information of a service which all shops included in the one or more groups can offer; and
setting or changing the accounting information of the service which all the shops included in the one or more groups can offer.

25. A computer readable memory storing a program, the program comprising the steps of:
managing information related to one or more groups each of which is formed of a plurality of shops;
storing the accounting information of a service which all shops included in the one or more groups can offer; and
setting or changing the accounting information of the service which all the shops included in the one or more groups can offer.

26. An information processing system comprising:
a first information processing apparatus comprising an order-issue means for ordering a certain service; and
a second information processing apparatus comprising:
accounting information storage means for storing the accounting information of a service which all shops included in one or more groups each of which is formed of a plurality of shops can offer; and
charge calculation means for calculating the charge for a certain service ordered by said order-issue means, according to the accounting information stored in said accounting information storage means.

27. An information processing system according to claim 26, wherein said order-issue means orders the certain service from a certain shop included in the one or more groups.

28. An information processing system according to claim 26, wherein said second information processing apparatus reports the calculation result of said charge calculation means to said first information processing apparatus or a shop specified by said order-issue means.

29. An information processing system according to claim 26, wherein the certain service is formed of one or more products.

30. An information processing system according to claim 26, wherein said charge calculation means calculates the charge for the certain service according to the accounting information of one or more products constituting the certain service.

31. An information processing system according to claim 26, wherein the accounting information of the certain service is formed of a basic charge and an amount charge.

32. An information processing system according to claim 26, wherein the accounting information of the certain service varies according to a period or an amount to be processed.

33. An information processing system according to claim 26, wherein the certain service makes at least one or more prints of a certain image.

34. An information processing system according to claim 26, wherein said first information processing apparatus is connected to said second information processing apparatus via a local area network or the Internet.

35. An information processing apparatus comprising:
accounting information storage means for storing the accounting information of a service which a shop included in one or more groups each of which is formed of a plurality of shops can offer; and
charge calculation means for calculating the charge for a certain service according to the accounting information stored in said accounting information storage means.

36. An information processing method comprising the steps of:
storing the accounting information of a service which all shops included in one or more groups each of which is formed of a plurality of shops can offer; and
calculating the charge for a certain service according to the stored accounting information.

37. A computer readable memory storing a program, the program comprising the steps of:
storing the accounting information of a service which all shops included in one or more groups each of which is formed of a plurality of shops can offer; and
calculating the charge for a certain service according to the stored accounting information.

38. An information processing system comprising:
a first information processing apparatus comprising:
accounting information storage means for storing the accounting information of a service which a shop included in one or more groups each of which is formed of a plurality of shops can offer; and
authentication means for authenticating the operations of a certain administrator, and
a second information processing apparatus comprising accounting information management means for managing the accounting information of a service which each group can offer, stored in said accounting information storage means, according to the authentication result of said authentication means.

39. An information processing system according to claim 38, wherein said accounting information storage means stores the accounting information of a service which a shop included in the one or more groups can offer, and the accounting information of one or more products constituting the service.

40. An information processing system according to claim 38, wherein said accounting information storage means stores the accounting information of a service which a shop included in the one or more groups can offer, and the accounting information unique to each shop of the service.

41. An information processing system according to claim 38, wherein said accounting information management means manages the accounting information of a service which all shops included in each group can offer, and the accounting information of one or more products constituting the service.

42. An information processing system according to claim 38, wherein said accounting information management means corrects and deletes a service which each group can offer, and registers the accounting information of a service newly offered by the group.

43. An information processing system according to claim 38, wherein said authentication means authenticates the operations of the certain administrator and allows only the certain administrator to manage the accounting information of the service.

44. An information processing system according to claim 38, wherein said authentication means allows a group administrator who manages the accounting information of a service which a certain group can offer, or the administrator of a certain shop included in each group who manages the accounting information of a service which the shop can offer to manage the accounting information of the service.

45. An information processing system according to claim 44, wherein the administrator of the shop can set the accounting information unique to the shop of a service which a certain group can offer, within a range allowed by the group administrator.

46. An information processing system according to claim 45, wherein said second information processing apparatus reports the management performed by the group administrator to the administrator of a shop included in the group which the group administrator manages.

47. An information processing system according to claim 45, wherein said second information processing apparatus reports the management performed by the shop administrator to the administrator of the group to which the shop which the shop administrator manages belongs.

48. An information processing system according to claim 38, wherein the accounting information of the service is formed of a basic charge and an amount charge.

49. An information processing system according to claim 38, wherein the accounting information of the service varies according to a period or an amount to be processed.

50. An information processing system according to claim 38, wherein a shop included in the group can offer a service other than a service which all shops included in the group can offer.

51. An information processing system according to claim 38, wherein the service makes one or more prints of a certain image.

52. An information processing system according to claim 38, wherein said information processing system includes a local area network or the Internet.

53. An information processing system according to claim 38, wherein said first information processing apparatus further comprises charge calculation means for calculating the charge of a certain service according to the service accounting information stored in said accounting information storage means.

54. An information processing system according to claim 38, wherein, when the accounting information unique to a shop included in the group is set, said charge calculation means gives priority to the accounting information unique to the shop over the accounting information of a service which the group can offer.

55. An information processing apparatus comprising:
accounting information storage means for storing the accounting information of a service which all shops included in one or more groups each of which is formed of a plurality of shops can offer; and
authentication means for authenticating the user who operates the accounting information of a service which each group can offer, stored in said accounting information storage means.

56. An information processing apparatus comprising:
accounting information management means for managing the accounting information of a service which a certain group can offer; and
control means for controlling such that the accounting information of the service, updated by the use of said accounting information management means is stored in an external unit according to the authentication result of the user who operates said accounting information management means.

57. An information processing method comprising the steps of:
storing the accounting information of a service which all shops included in one or more groups each of which is formed of a plurality of shops can offer;
authenticating the operations of a certain administrator; and
managing the accounting information of a service which each group can offer, according to the authentication result.

58. A computer readable memory storing a program, the program comprising the steps of:
storing the accounting information of a service which all shops included in one or more groups each of which is formed of a plurality of shops can offer;
authenticating the operations of a certain administrator; and
managing the accounting information of a service which each group can offer, according to the authentication result.
